(19) United States
(12) Patent Application Publication
(10) Pub. No.: US 2025/0023822 A1
(43) Pub. Date: Jan. 16, 2025

(54) TECHNIQUES FOR SAVING ROUTER POWER CONSUMPTION

(71) Applicant: Huawei Technologies Co., Ltd., Shenzhen (CN)

(72) Inventors: Lijun DONG, San Diego, CA (US); Renwei Li, Sunnyvale, CA (US)

(73) Assignee: Huawei Technologies Co., Ltd., Shenzhen (CN)

(21) Appl. No.: 18/900,394

(22) Filed: Sep. 27, 2024

Related U.S. Application Data
(63) Continuation of application No. PCT/US2022/080554, filed on Nov. 29, 2022.
(60) Provisional application No. 63/362,266, filed on Mar. 31, 2022.

(51) Int. Cl. H04L 47/125; H04L 45/12; H04L 45/745

(52) U.S. Cl. CPC H04L 47/125; H04L 45/123; H04L 45/745

(57) ABSTRACT

A method for routing data traffic in a communication network includes decoding, by a source node, an Internet protocol (IP) data packet to determine a destination node. A routing table for the destination node is retrieved. The routing table identifies a plurality of next-hop nodes associated with a corresponding plurality of routing paths to the destination node. A plurality of saturation metrics corresponding to the plurality of routing paths are determined using the routing table. Each of the plurality of saturation metrics is indicative of data traffic saturation along a corresponding one of the plurality of routing paths. A routing path is selected from the plurality of routing paths based on the plurality of saturation metrics. The IP data packet is forwarded to a next-hop node in the selected routing path.

### CROSS-REFERENCE TO RELATED APPLICATIONS

This application is a continuation of International Application No. PCT/US2022/080554, filed Nov. 29, 2022, which claims the benefit of priority to U.S. Provisional Application No. 63/362,266, filed on Mar. 31, 2022, entitled “TECHNIQUES FOR SAVING ROUTER POWER CONSUMPTION,” which provisional application is incorporated herein by reference in its entirety.

### TECHNICAL FIELD

The present disclosure is related to configuring power consumption in network devices, including reducing power consumption in network routers.

### BACKGROUND

The Information and Communication Technology (ICT) sector currently consumes 5-9% of global energy consumption, but with the rapid growth in digitization this could reach as high as 20% soon, due to the increasing network usage and further deployment requirements for network infrastructures. Green networking not only has a significant environmental impact but also pronounced economic impact. Such impact arises from the application of cost reduction measures by the service providers to maintain the network infrastructure running at the optimal status while counterpoising the increasing energy costs. In 2020, the ICT industry set a Science-Based Pathway to reach net-zero GHG (Greenhouse Gas) emissions by 2050. Disruptive architecture solutions, protocols, and innovative devices are means for researchers to achieve such goals. It is becoming of increasing importance for technology companies to develop energy-efficient products (e.g., routers, switches, and other network products), as well as network protocols and services.

### SUMMARY

Various examples are now described to introduce a selection of concepts in a simplified form that is further described below in the detailed description. The Summary is not intended to identify key or essential features of the claimed subject matter, nor is it intended to be used to limit the scope of the claimed subject matter.

According to a first aspect of the present disclosure, there is provided a method for routing data traffic in a communication network. The method includes decoding, by a source node in the communication network, an Internet protocol (IP) data packet to determine a destination node. The method further includes retrieving, by the source node, a routing table for the destination node. The routing table identifies a plurality of next-hop nodes associated with a corresponding plurality of routing paths to the destination node. The method further includes determining, by the source node, a plurality of saturation metrics corresponding to the plurality of routing paths using the routing table. Each of the plurality of saturation metrics is indicative of data traffic saturation along a corresponding one of the plurality of routing paths. The method further includes selecting a routing path from the plurality of routing paths based on the plurality of saturation metrics. The method further includes forwarding the IP data packet to a next hop node in the selected routing path.

In a first implementation form of the method according to the first aspect as such, the selecting of the routing path further includes selecting a highest saturation metric from the plurality of saturation metrics, the highest saturation metric corresponding to the routing path.

In a second implementation form of the method according to the first aspect as such or any preceding implementation form of the first aspect, the method further includes detecting the highest saturation metric is higher than a threshold saturation metric.

In a third implementation form of the method according to the first aspect as such or any preceding implementation form of the first aspect, the method further includes selecting a second routing path from the plurality of routing paths, the second routing path having a second highest saturation metric from the plurality of saturation metrics. The method further includes switching routing the IP data packet from the selected routing path to the second routing path.

In a fourth implementation form of the method according to the first aspect as such or any preceding implementation form of the first aspect, the plurality of saturation metrics is a plurality of average load saturation ratios (LSRs) corresponding to the plurality of routing paths.

In a fifth implementation form of the method according to the first aspect as such or any preceding implementation form of the first aspect, an average LSR of the plurality of average LSRs corresponding to the selected routing path is based on at least one ratio of data traffic load to a maximum peak load supported by a node in the selected routing path before data traffic congestion occurs at the node.

In a sixth implementation form of the method according to the first aspect as such or any preceding implementation form of the first aspect, the method further includes parsing the routing table to determine a saturation metric and communication status for at least a first set of nodes forming the selected routing path and a second set of nodes forming a second routing path of the plurality of routing paths.

In a seventh implementation form of the method according to the first aspect as such or any preceding implementation form of the first aspect, the method further includes detecting network congestion for the selected routing path is above a threshold congestion level. The method further includes detecting the communication status in the routing table for a node of the second set of nodes indicates the node is turned off. The method further includes encoding a configuration message for transmission to a management node of the communication network based on detecting the network congestion and the communication status. The configuration message requests the management node to turn on the node of the second set of nodes.

In an eighth implementation form of the method according to the first aspect as such or any preceding implementation form of the first aspect, the method further includes detecting available communication interfaces of the source node have been idle for a threshold duration. The method further includes encoding a configuration message for transmission to a management node of the communication network. The configuration message requests the management node to turn off the source node.

In a ninth implementation form of the method according to the first aspect as such or any preceding implementation form of the first aspect, the method further includes encoding a notification message for a broadcast within the communication network. The notification message includes at least a first field indicating the saturation metric for each of the available communication interfaces, and at least a second field indicating a sleeping status of the source node.

In a tenth implementation form of the method according to the first aspect as such or any preceding implementation form of the first aspect, the sleeping status indicates the source node is in a drowsy state. The drowsy state is associated with the source node being turned off within a preconfigured interval after the notification message is broadcast.

In an eleventh implementation form of the method according to the first aspect as such or any preceding implementation form of the first aspect, the notification message is a link state advertisement (LSA) message, the at least a first field includes a metric field, and the at least a second field includes a type field.

In a twelfth implementation form of the method according to the first aspect as such or any preceding implementation form of the first aspect, the at least a first field is a metadata field of the notification message.

In a thirteenth implementation form of the method according to the first aspect as such or any preceding implementation form of the first aspect, the method further includes updating the communication status of the source node listed in the routing table to indicate the sleeping status.

In a fourteenth implementation form of the method according to the first aspect as such or any preceding implementation form of the first aspect, the method further includes detecting a communication interface of a plurality of available communication interfaces of the source node has been idle for a threshold duration. The method further includes encoding a configuration message for transmission to a management node of the communication network, the configuration message requesting the management node to turn off the communication interface.

In a fifteenth implementation form of the method according to the first aspect as such or any preceding implementation form of the first aspect, the method further includes encoding a notification message for a broadcast within the communication network. The notification message includes at least a first field indicating the saturation metric for the communication interface, and at least a second field indicating a sleeping status of the communication interface.

In a sixteenth implementation form of the method according to the first aspect as such or any preceding implementation form of the first aspect, the sleeping status indicates the communication interface is in a drowsy state. The drowsy state is associated with the communication interface being turned off within a preconfigured interval after the notification message is broadcast.

In a seventeenth implementation form of the method according to the first aspect as such or any preceding implementation form of the first aspect, the notification message is a link state advertisement (LSA) message, the at least a first field includes a metric field, and the at least a second field includes a type field.

In an eighteenth implementation form of the method according to the first aspect as such or any preceding implementation form of the first aspect, the at least a first field is a metadata field of the notification message.

In a nineteenth implementation form of the method according to the first aspect as such or any preceding implementation form of the first aspect, the method further includes updating the communication status of the source node listed in the routing table to indicate the sleeping status.

In a twentieth implementation form of the method according to the first aspect as such or any preceding implementation form of the first aspect, the method further includes parsing the routing table to determine a saturation metric and communication status for a plurality of nodes forming the plurality of routing paths.

In a twenty-first implementation form of the method according to the first aspect as such or any preceding implementation form of the first aspect, the method further includes decoding a notification message broadcast by at least one node of the plurality of nodes. The at least one node is associated with a second routing path of the plurality of routing paths. The notification message indicates the saturation metric for a communication interface of the at least one node is below a threshold saturation metric.

In a twenty-second implementation form of the method according to the first aspect as such or any preceding implementation form of the first aspect, the method further includes excluding the second routing path from the plurality of routing paths during the selecting of the routing path, based on the notification message.

According to a second aspect of the present disclosure, there is provided a method for configuring one or more of a plurality of nodes in a communication network. The method includes detecting, by at least one hardware processor of a first node of the plurality of nodes, available communication interfaces of the first node have been idle for a threshold duration. The method further includes encoding, by the at least one hardware processor, a configuration message for transmission to a second node of the plurality of nodes. The configuration message requests the second node to turn off the first node. The method further includes encoding, by the at least one hardware processor, and before the second node turns off the first node, a notification message for a broadcast within the communication network. The notification message indicates a sleeping status of the first node.

In a first implementation form of the method according to the second aspect as such, the operations further include encoding at least a first field of the notification message to indicate a saturation metric for each communication interface of the available communication interfaces. The saturation metric is indicative of data traffic saturation along a corresponding routing path of a plurality of routing paths in the communication network. The routing path includes the communication interface. The method further includes encoding at least a second field of the notification message to indicate the sleeping status of the first node.

In a second implementation form of the method according to the second aspect as such or any preceding implementation form of the second aspect, the sleeping status indicates the first node is in a drowsy state. The drowsy state is associated with the first node being turned off within a preconfigured interval after the notification message is broadcast within the communication network.

In a third implementation form of the method according to the second aspect as such or any preceding implementation form of the second aspect, the notification message is a link state advertisement (LSA) message, the at least a first field includes a metric field, and the at least a second field includes a type field.

In a fourth implementation form of the method according to the second aspect as such or any preceding implementation form of the second aspect, the at least a first field is a metadata field of the notification message.

According to a third aspect of the present disclosure, there is provided a method for configuring one or more of a plurality of nodes in a communication network. The method includes detecting, by at least one hardware processor of a first node of the plurality of nodes, a communication interface of a plurality of available communication interfaces of the first node has been idle for a threshold duration. The method further includes encoding, by the at least one hardware processor, a configuration message for transmission to a second node of the plurality of nodes. The configuration message requests the second node to turn off the communication interface. The method further includes encoding, by the at least one hardware processor, and before the second node turns off the communication interface, a notification message for a broadcast within the communication network. The notification message indicates a sleeping status of the communication interface.

In a first implementation form of the method according to the third aspect as such, the operations further include encoding at least a first field of the notification message to indicate a saturation metric for each communication interface of the plurality of available communication interfaces. The saturation metric is indicative of data traffic saturation along a corresponding routing path of a plurality of routing paths in the communication network. The routing path includes the communication interface. The method further includes encoding at least a second field of the notification message to indicate the sleeping status of the communication interface.

In a second implementation form of the method according to the third aspect as such or any preceding implementation form of the third aspect, the sleeping status indicates the communication interface is in a drowsy state. The drowsy state is associated with the communication interface of the first node being turned off within a preconfigured interval after the notification message is broadcast within the communication network.

In a third implementation form of the method according to the third aspect as such or any preceding implementation form of the third aspect, the notification message is a link state advertisement (LSA) message, the at least a first field includes a metric field, and the at least a second field includes a type field.

In a fourth implementation form of the method according to the third aspect as such or any preceding implementation form of the third aspect, the at least a first field is a metadata field of the notification message.

According to a fourth aspect of the present disclosure, there is provided an apparatus of a source node for routing data traffic in a communication network. The apparatus includes memory storing instructions and at least one processor in communication with the memory. The at least one processor is configured, upon execution of the instructions, to perform operations specified by one or more of the above method aspects.

According to a fifth aspect of the present disclosure, there is provided a non-transitory computer-readable medium storing computer instructions for routing data traffic in a communication network. The instructions when executed by one or more processors of a source node, cause the one or more processors to perform operations specified by one or more of the above method aspects.

Anyone of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a high-level system overview of a network architecture with network nodes including a power management module, according to some example embodiments.

FIG. 2 is a diagram of a router architecture, which can be used in connection with some example embodiments.

FIG. 3 is a graph showing example energy consumption in routers, which can be used in connection with some example embodiments.

FIG. 4 illustrates a New IP header and data format which can be used in the network architecture of FIG. 1 in connection with some example embodiments.

FIG. 5 illustrates an example New IP packet in an Ethernet frame, which can be used in connection with some example embodiments.

FIG. 6 illustrates an example contract specification field in the New IP data packet of FIG. 4, which can be used in connection with some example embodiments.

FIG. 7 illustrates an example of a contract clause in the contract specification field of FIG. 6, which can be used in connection with some example embodiments.

FIG. 8 illustrates an example of actions that may be specified in a contract clause, which can be used in connection with some example embodiments.

FIG. 9 illustrates an example of events and conditions that may be specified in a contract clause, which can be used in connection with some example embodiments.

FIG. 10 is an example network architecture topology, according to some example embodiments.

FIG. 11 is a diagram of a table with example router link types, according to some example embodiments.

FIG. 12 is a diagram of a routing table when all routers of the network architecture topology of FIG. 10 are active, according to some example embodiments.

FIG. 13 is an example network architecture topology with one router configured in a sleeping mode, according to some example embodiments.

FIG. 14 is a diagram of a routing table associated with the network architecture topology of FIG. 13 when one router is in sleeping mode, according to some example embodiments.

FIG. 15 is an example network architecture topology with a management node, according to some example embodiments.

FIG. 16 is a flowchart of a method suitable for data packet communication and processing, according to some example embodiments.

FIG. 17 is a block diagram illustrating a representative software architecture, which may be used in conjunction with various device hardware described herein, according to some example embodiments.

FIG. 18 is a block diagram illustrating circuitry for a device that implements algorithms and performs methods, according to some example embodiments.

### DETAILED DESCRIPTION

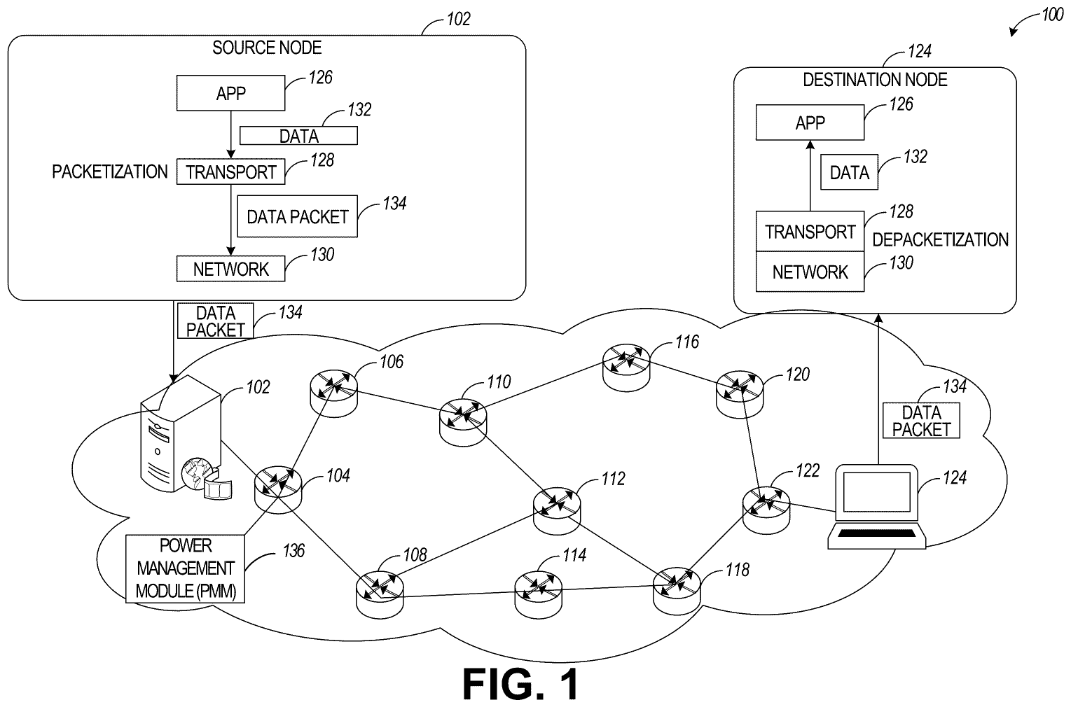

It should be understood at the outset that although an illustrative implementation of one or more embodiments is provided below, the disclosed systems and/or methods described with respect to FIGS. 1-18 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and which are shown, by way of illustration, specific embodiments which may be practiced. These embodiments are described in sufficient detail to enable those skilled in the art to practice the inventive subject matter, and it is to be understood that other embodiments may be utilized, and that structural, logical, and electrical changes may be made without departing from the scope of the present disclosure. The following description of example embodiments is, therefore, not to be taken in a limiting sense, and the scope of the present disclosure is defined by the appended claims.

As used herein, the term “network architecture” includes a plurality of computing devices (also referred to as hosts, nodes, routers, or servers) communicatively coupled in a network. In some aspects, the network architecture can be referred to as an autonomous system (AS). In some aspects, the network architecture can include a management node (also referred to as an orchestration node, an orchestrator, a node controller, or a router controller). In some aspects, the management node can be part of the AS or can be an external device associated with another AS. As used herein, the term “source node” indicates a node in the network architecture which is configured as the originating node of a subsequent data packet transmission within the AS. In some aspects, a node can receive a data packet at a first time instance (e.g., the node can be referred to as a receiving node) and can transmit the data packet to another node in a second time instance (e.g., the node can be referred as a source node). The source node can also indicate the node that performs the first (initial) transmission of the data packet. As used herein, the term “destination node” indicates a node in the network architecture that is configured to receive the data packet (e.g., as specified by the data packet header) within the AS. Even though the disclosed techniques are described as being performed by a source node, the present specification is not limited in this regard and the disclosed techniques can be performed by other nodes in the AS.

In some aspects, the network architecture can be configured as a “network-based service infrastructure” with the computing devices configured to provide on-demand computing capacity (e.g., via one or more virtual machines or other virtual resources running on the network devices) and storage capacity as a service to a community of end-recipients (e.g., customers of the service infrastructure) where the end recipients are communicatively coupled to the network devices within the service infrastructure via a network. The customers of the service infrastructure can use one or more computing devices (or customer devices) to access and manage the services (e.g., workload scheduling services) provided by the service infrastructure via the network. The customer devices, the network, and the network-based service infrastructure can be collectively referred to as a “network architecture.” The customers of the service infrastructure can also be referred to as “users.”

Some techniques for managing node power consumption (e.g., scheduling network components to sleep mode) can be distinguished into two categories: decremental and incremental approaches. In the decremental approach, network devices in the original topology are switched off one after another considering the network traffic and quality of service (QoS) constraints. The incremental approach is based on starting with a small initial topology that satisfies the minimum connectivity constraints, then devices are added to the network to ensure the desired performance. The decremental approach considers achieving maximum energy conservation as the highest priority while the incremental approach prioritizes the guarantee of the QoS performance.

The incremental approaches can be based on a centralized decision structure, and most of the decremental approaches can use a central controller for sleep scheduling decisions. The centralized controller has holistic knowledge of the network, however, the control overhead to apprehend the global knowledge and reach a remote decision can be significant. The power management algorithm execution and deployment complexity can diminish the benefits of energy consumption reduction by putting the network nodes in sleep mode because the centralized controller could consume inordinately high energy in executing the algorithms repeatedly.

The disclosed power management techniques are based on sleeping and standby approaches, which allow devices, components of the devices, and device interfaces/links to be placed in sleep or idle mode. More specifically, the disclosed techniques use load saturation aware routing (e.g., based on a load saturation ratio or LSR) to configure switching off a node (e.g., a router) or an interface of a router by steering the traffic flows to routers with higher saturation rate if there are multiple forwarding paths towards the destination.

FIG. 1 is a high-level system overview of a network architecture 100 with a power management module, according to some example embodiments. The network architecture 100 (which can also be referred to as AS 100) includes, for example, a source node 102, a destination node 124, and intermediate nodes 104, 106, 108, 110, 112, 114, 116, 118, 120, and 122.

The source node 102, the destination node 124, and any of the intermediate nodes 104-122 can be any type of electronic device capable of communicating over a communication network such as, but not limited to, a mobile communication device, an Internet-of-things (IoT) device, a personal computer, a server, a router, a mainframe, a database, or any other type of user or a network device. For example, the source node 102 can be a media server, and the destination node 124 can be a mobile device that receives media content from the source node 102.

In the depicted embodiment, the source node 102 executes one or more programs/applications (APP) 126. The APP 126 can be any type of software application, which produces or otherwise generates data 132. Data 132 can be any type of data depending on the functions of APP 126. For example, in one embodiment, the data 132 can be multi-media data (e.g., audio and/or video data) that is generated by the source node 102 and is pushed (or communicated) to the destination node 124 via the intermediate nodes 104-122. Alternatively, data 132 can be data that is specifically requested from the source node 102 by the destination node 124.

For example, to communicate data 132 to the destination node 124, APP 126 on the source node 102 uses an application programming interface (API) to communicate the data 132 to transport layer 128 of the source node 102. Transport layer 128 is responsible for delivering the data 132 to the appropriate APP 126 on the destination node 124. The transport layer 128 bundles/organizes the data into one or more data packets (e.g., data packet 134) according to a specific protocol (e.g., packetization or transport protocol such as RTP). For instance, the transport layer 128 may use various communication protocols such as, but not limited to, Transmission Control Protocol/Internet protocol (TCP/IP) or RTP for providing host-to-host communication services such as connection-oriented communication, reliability, flow control, and multiplexing.

The data packet 134 is transferred to network layer 130 of the source node 102. The network layer 130 is responsible for packet forwarding including routing of the data packet 134 through one or more of the intermediate nodes 104-122 of the network architecture 100. The network architecture 100 can comprise multiple interconnected networks including, but not limited to, a local area network (LAN), a metropolitan area network (MAN), a wide area network (WAN), a wireless or a mobile network, and an inter-network (e.g., the Internet), or a combination thereof. When a data packet 134 reaches the destination node 124, data 132 is extracted from the data packet 134 (e.g., during depacketization) and is passed to APP 126 on the destination node 124 for further processing.

Although FIG. 1 illustrates one example of a network architecture 100, various changes may be made to FIG. 1. For example, the network architecture 100 could include any number of source nodes, destination nodes, or intermediate nodes (e.g., nodes 104-122), access points, networks, or other components in any suitable configuration.

In some embodiments, nodes 102-124 are each configured with a power management module (or PMM) (e.g., similar to PMM 136 of node 104) which is used in connection with (e.g., can be configured to perform) the disclosed power management techniques based on load saturation aware routing.

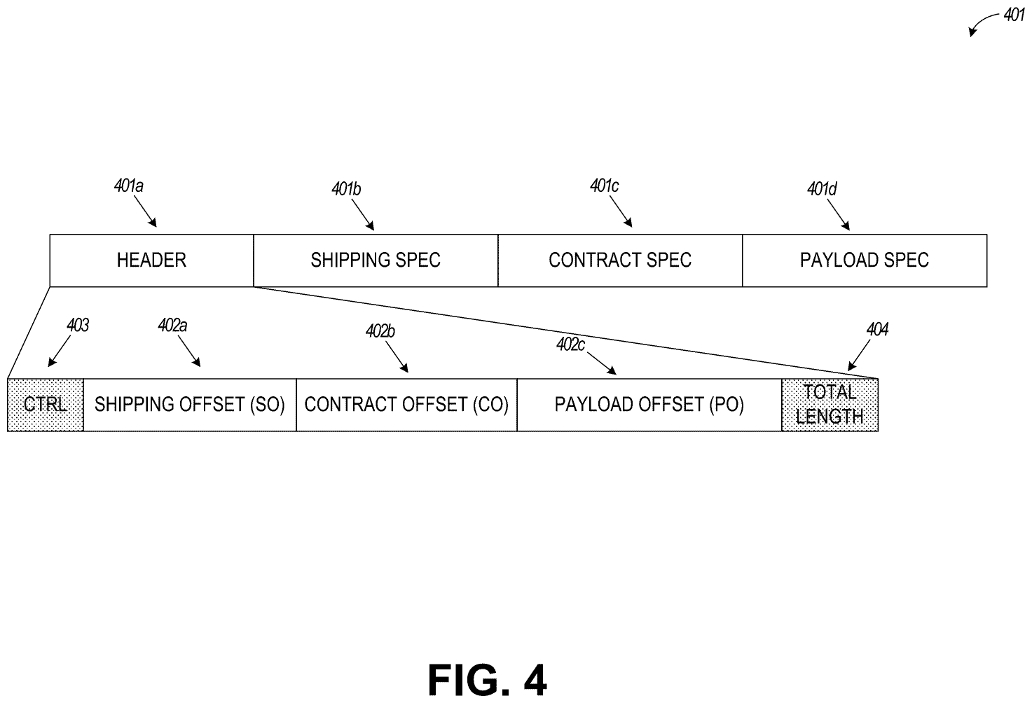

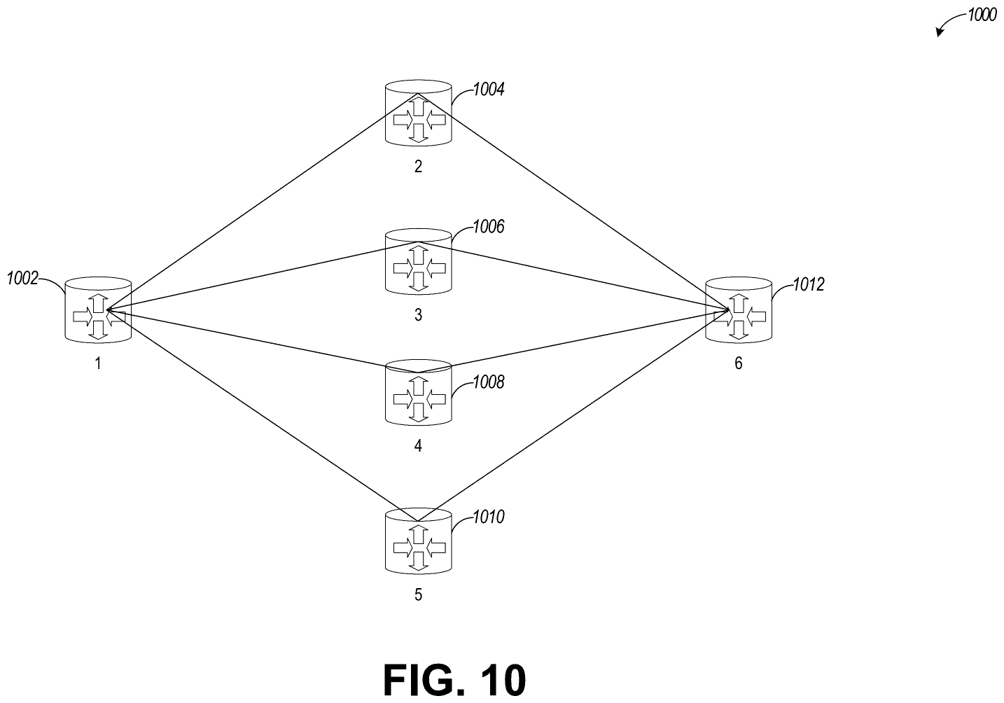

In some embodiments, one or more of the network nodes 102-124 (e.g., routers) can be upgraded to have New IP functionalities (e.g., as discussed in connection with FIGS. 4-9). If a node is configured with New IP functionalities, the LSR values (e.g., associated with at least one router or at least one interface of a router) can be propagated in the New IP packet header (e.g., using the New IP metadata field). Additional configurations related to power management based on load saturation-aware routing are discussed in connection with FIGS. 10-18.

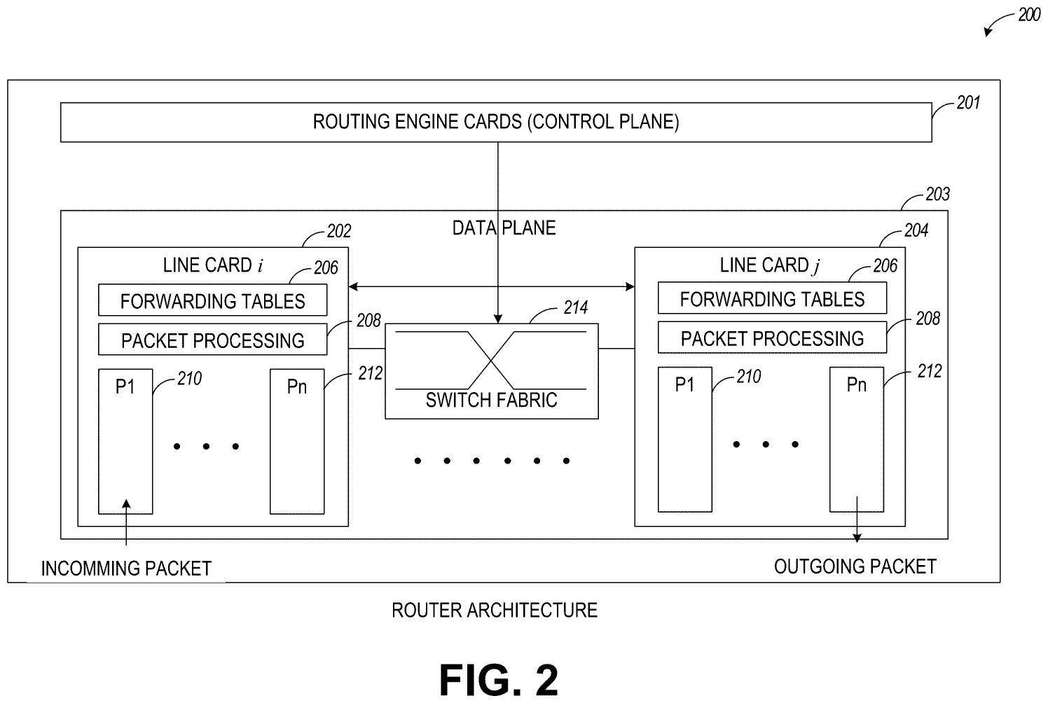

FIG. 2 is a diagram of a router architecture 200, which can be used in connection with some example embodiments. Referring to FIG. 2, the router architecture 200 (or router 200) includes a control plane 201 and a data plane 203. The control plane 201 can include one or more routing engine cards. The data plane 203 can include includes line cards 202, . . . , 204, with each line card including forwarding tables 206 and packet processing logic 208. The line cards 202, . . . , 204, and control plane 201 are interconnected via switch fabric 214. Incoming packets 210 are processed by the line cards to generate outgoing packets 212.

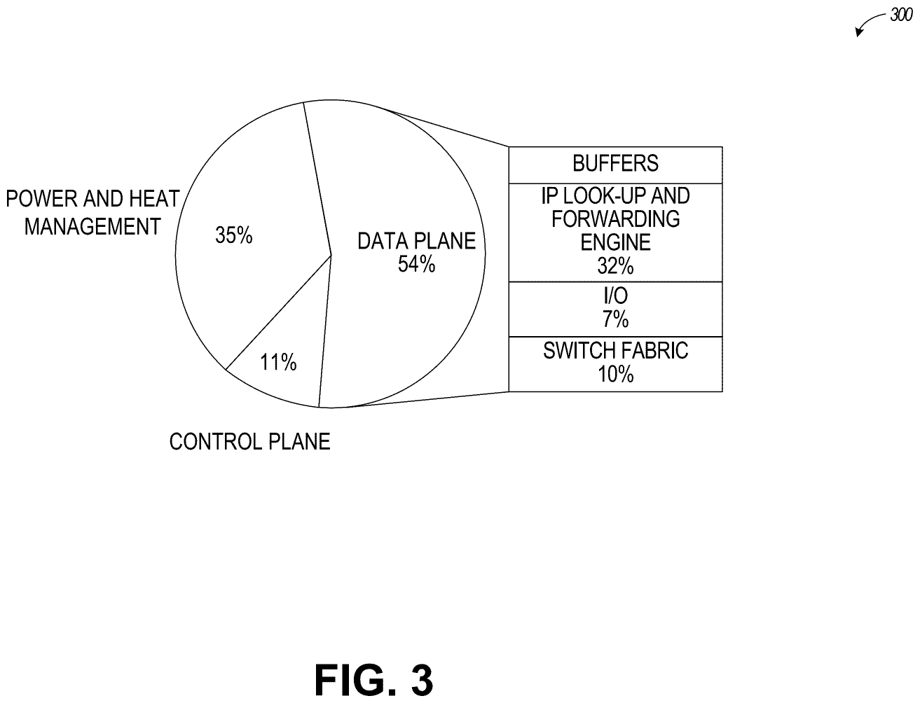

FIG. 3 is graph 300 showing energy consumption in routers, which can be used in connection with some example embodiments. The energy consumption of a router is made up of two parts: static and dynamic energy. Static energy is consumed by the Line-Card Chassis (LCC) and dynamic energy is consumed by the line cards (e.g., line cards 202, . . . , 204) and is related to the traffic load. As illustrated in FIG. 3, for each configuration, the base system consumes more than half the maximum observed power consumption for any configuration. The power consumption of a router at its peak traffic load is only slightly larger than its power consumption at its idle state. On the other hand, switching off the router can save more energy than only switching off the line cards since the consumption of the base system is the major contributor to the overall energy consumption. In this regard, if traffic is all forwarded to those routers that already have a certain degree of traffic load, some routers that are in an idle state could be turned off, or some interfaces of a router could be turned off to save energy consumption. Such power management, including turning off a router or a router interface, can be performed based on the disclosed load saturation-aware routing techniques.

FIG. 4 illustrates a diagram of a New IP header and data format which can be used in the network architecture of FIG. 1 in connection with some example embodiments. The New IP data packet 401 is part of an Internet framework that brings several capabilities in the present technology. New IP is a data plane technology that defines a new IP packet format, its specification, and corresponding capabilities in the network nodes. Using the present technology, new and upcoming applications, such as industrial Internet, vehicle-to-infrastructure, autonomous systems, holographic type communications, etc., may be enabled over communication networks. The New IP data packet 401 may be used for data transmission over a wide variety of networks having different capabilities and requirements. However, other variations of new IP data packets are also part of this application, including the described specifications, subsets of the described specifications, and combinations of the described specifications with other specifications. These can all be collectively considered as New IP data packets for purposes of the present disclosure.

As illustrated in FIG. 4, the New IP data packet 401 includes a header field 401a, followed by a shipping specification field 401b, a contract specification field 401c, and a payload specification field 401d. It is appreciated that the order of the specifications as illustrated is one embodiment and that the specification may be placed in any order. It is also appreciated that additional or fewer specifications may be included in the format. For example, one format may only include the shipping specification field and the payload specification field, whereas another format may include the contract specification and payload specification field. In another example, additional specifications may be added.

The header field 401a identifies the beginning of the data packet 401 and describes offsets for the specification fields. For example, the header field 401a includes a shipping offset (or pointer) 402a of the shipping specification field 401b, a contract offset (or pointer) 402b of the contract specification field 401c, and a payload offset (or pointer) 402c of the payload specification field 401d. In one embodiment, the header field 401a may also include a signature field (CTRL) 403, such as implementation-specific details (e.g., flags) and a total length 404 of the packet. In a further embodiment, the offset of a specification and the total length of the packet may indicate whether the packet is corrupt. For example, when none of the offsets exceed the total length of the packet, the packet is not corrupt. In another example, the packet may be corrupt when one of the offsets exceeds the total length of the packet. For instance, the payload offset 402c may be set to a length of 20 and the total length of the offsets may be set to 10. Since the payload offset length is greater than the total length of the offsets, the packet may be identified as corrupt.

In another embodiment, the signature field (CTRL) 403 may indicate whether the header has been corrupted during transit. For example, the signature field may be a hash, a cyclic redundancy check (CRC), or a public/private key mechanism. Other variations in these fields are also possible. For example, in some embodiments, the payload specification field 401d can include a field indicating its length, which can be used with the offsets to compute the length of the entire packet. Similarly, in some embodiments, the header field 401a can include a shipping offset 402a and lengths of the shipping specification and the contract specification, instead of the contract offset and the payload offset. More generally, a combination of offsets and/or lengths of the various fields can indicate their locations and lengths in the packet.

The shipping specification field 401b provides flexible and contextual addressing in heterogeneous networks and inter-networking systems. In one embodiment, the shipping specification field 401b allows for different types and formats of addresses based on the functionality and network connecting devices. In one other embodiment, the shipping specification field 401b enables backward compatibility with existing addressing schemes, such as IPv4 and IPv6.

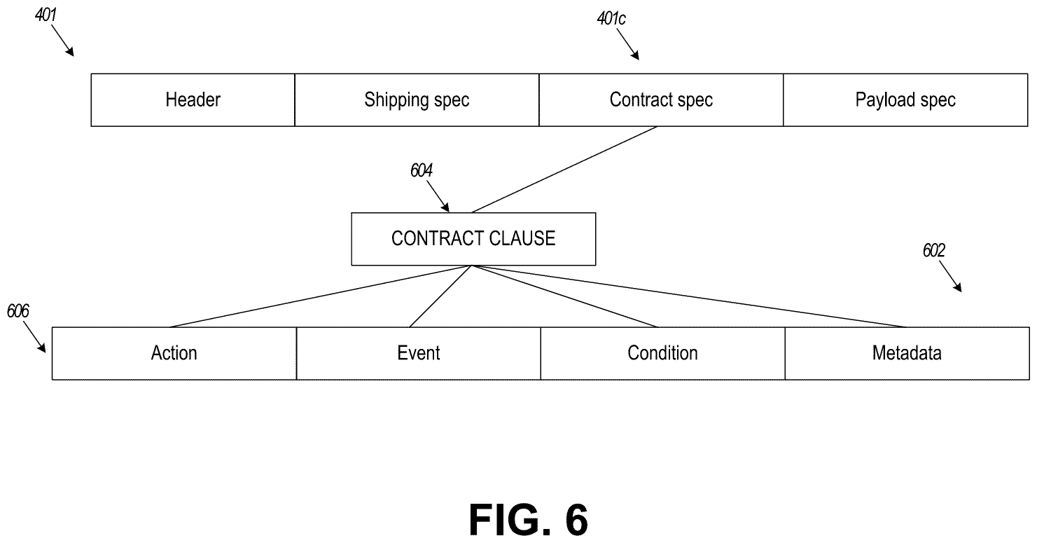

The contract specification field 401c supports service and application awareness, where a contract specified in the contract specification field 401c allows for robust service delivery models and provides guarantees of Service Level Objectives (SLO) such as latency, capacity, reliability, etc. In one embodiment, the contract specification field 401c focuses on high-precision communication (HPC) and the life cycle of any type of service in the network to enable a variety of services, as well as their operational and administrative control at the finest packet-level granularity. The contract in the contract specification field 401c creates avenues for the next generation of programmability, customization, and non-monolithic data plane pipelines, while also providing the ability to satisfy requirements to perform telemetry, elastically grow services on-demand, and create new business models around HPC. The contract specification field 401c is described in more detail below with reference to FIGS. 6-9.

The payload specification field 401d specifies capabilities through which entropy and quality of information are carried in the payload and which may be used to improve throughput and achieve robustness of data transmission. In one embodiment, the payload specification field 401d associates semantics, such as user-defined or application semantics, with the user data while maintaining payload integrity. For example, when a data packet is received by a node from an end-user in the network, the data payload remains usable even if the payload does not match bit-by-bit with the payload from the sender. Rather, using the semantics associated with the user data, the source node may use partial information carried in the payload. This partial-packet reception helps to mitigate re-transmission overhead and delays when faced with slow or congested conditions.

Accordingly, using the various specifications, the new IP data packet 401 is flexible and may be changed or modified to suit the particular needs of a network operation or conditions presented in the network. For example, and for purposes of discussion, assume that addressing enhancements are an essential requirement in a particular network implementing the new IP data packet. To enhance addressing, an operator can deploy and manage to address features using the shipping specification field 401b. Similarly, if a need for Beyond Best-Effort (BBE) service-aware infrastructure is more critical, then the contract specification field 401c may be deployed by the network operator. Later, as needs for payload enhancements become necessary, the payload specification field 401d may be incorporated into the network.

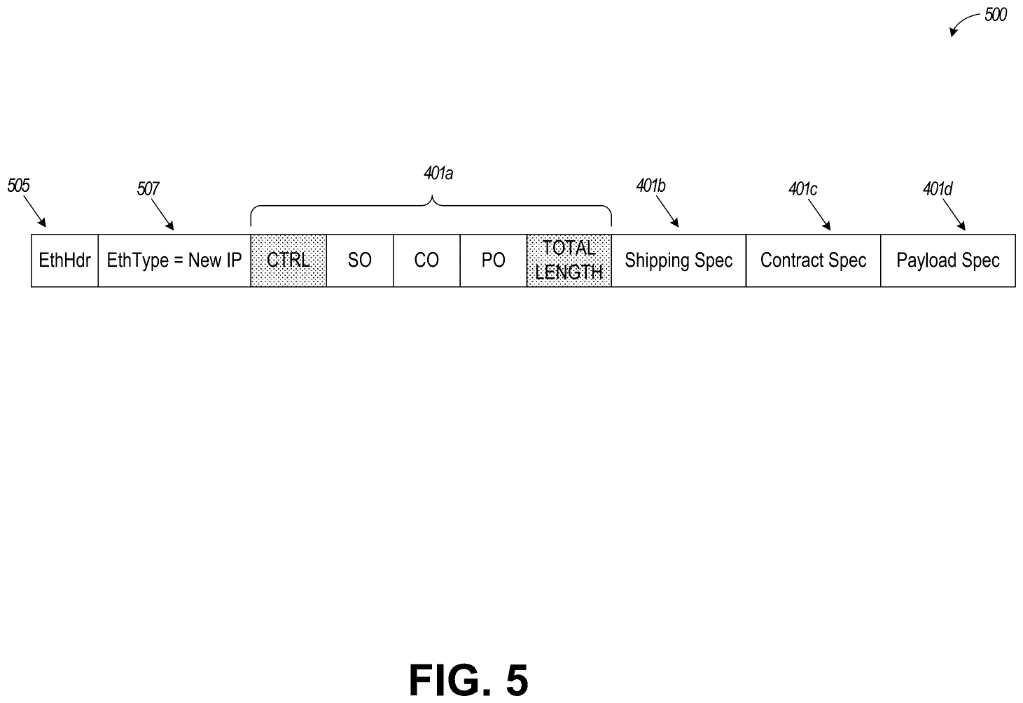

One example embodiment of the New IP data packet 401 is shown in FIG. 5. FIG. 5 illustrates an example New IP packet in an Ethernet frame 500, which can be used in connection with some example embodiments. In the depicted embodiment, an Ethernet header (EthHdr) field 505 is followed by an Ethernet type (Eth Type) field 507, which specifies that the type is a New IP format of the New IP data packet 401. The New IP format is encapsulated by the Ethernet frame 500 and includes a header field 401a, the shipping specification field 401b, the contract specification field 401c, and the payload specification field 401d.

FIG. 6 illustrates an example contract specification field in the New IP data packet of FIG. 4, which can be used in connection with some example embodiments. The New IP data packet 401 is described above with reference to FIG. 4 and FIG. 5. The current embodiment focuses on the contract specification field of the New IP data packet format.

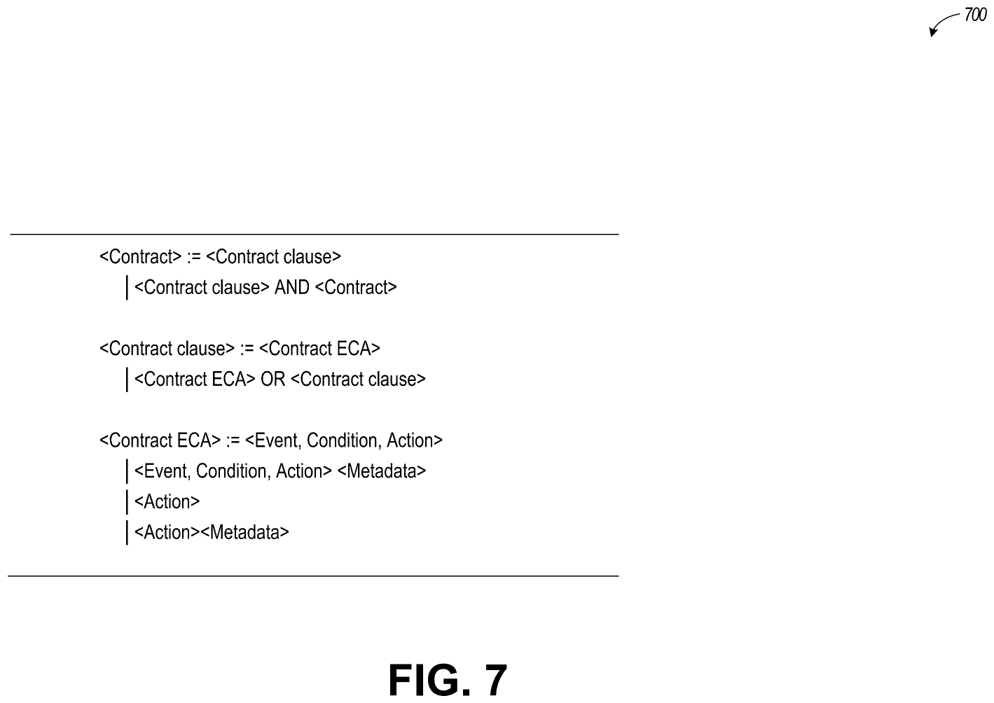

FIG. 7 illustrates an example of a contract clause 700 (or contract 700) in the contract specification field of FIG. 6, which can be used in connection with some example embodiments.

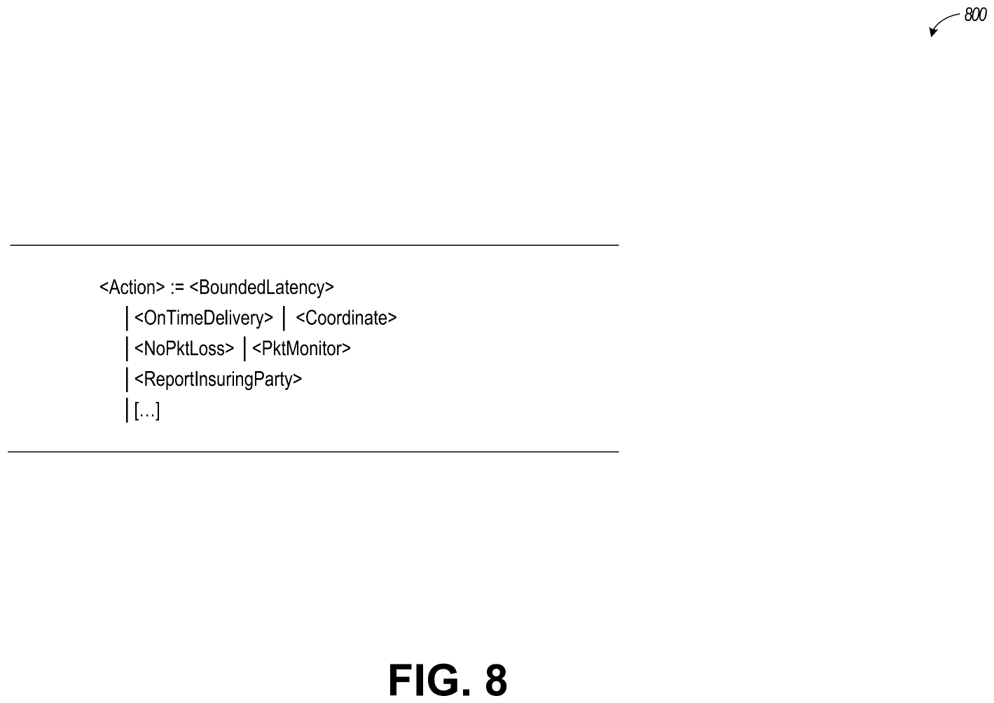

FIG. 8 illustrates an example of action 800 that may be specified in a contract clause, which can be used in connection with some example embodiments.

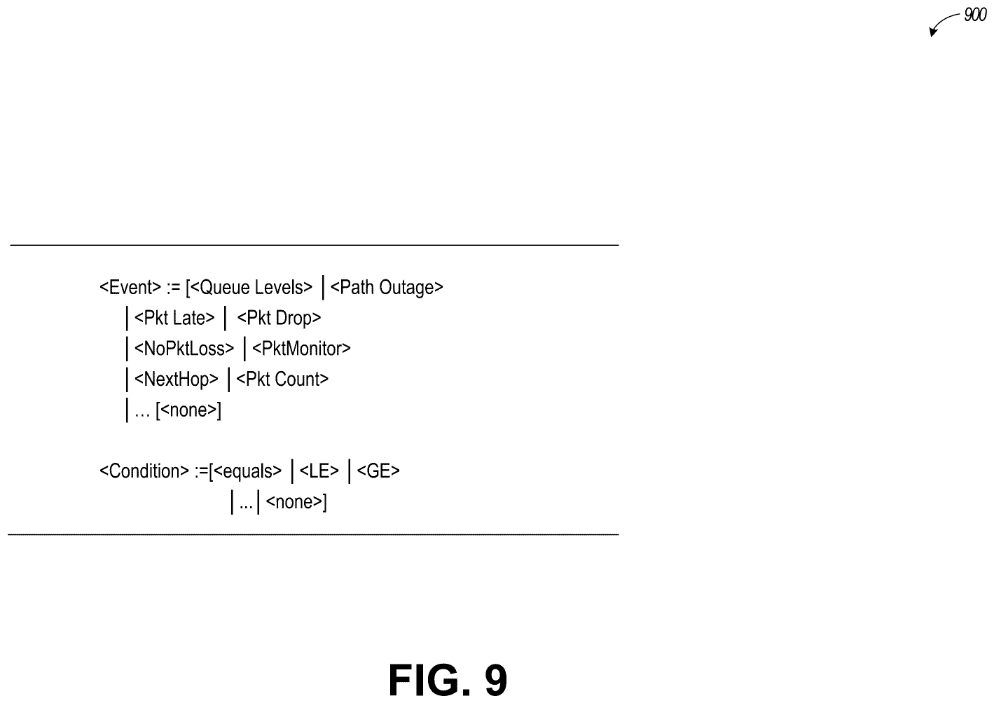

FIG. 9 illustrates an example of events and conditions 900 that may be specified in a contract clause, which can be used in connection with some example embodiments.

The contract specification field 401c enables a large selection of network capabilities, their functioning, and regulative control at the finest packet-level granularity. The contract specification field 401c may include several contract clauses (e.g., contract clause 604, also referred to as one or more contract clauses 604). Contract clause 604 independently defines service-specific actions, events, and conditions. Production rules for a contract may be represented in a context-free grammar style, as shown in FIG. 7. In some aspects, nodes in the network architecture 100 fulfill the contract 700, assuming the contract is agreed to by the packet sender (e.g., source node 102) and the packet receiver (e.g., destination node 124). Contract 700 describes a formal service-specific arrangement between two or more parties, which includes one or more contract clauses 604 to describe the type of network service capability, actions, and accounting information.

In one embodiment, contract 700 is of a fixed length. In another embodiment, contract 700 is of variable length. In the case of more than one contract, the location of contract 700 may be determined by a list of offsets associated with each contract.

In some aspects, service assurance requirements at a packet level are provided through the use of contract 700. In particular, contract 700 carries any combination of specific attributes associated with time-engineered services, high-throughput media services, mission-critical ultra-reliable services, and other services. In one embodiment, the structure of contract 700 is defined in a Chomsky style. For example, a contract 700 can follow one or more contracts, where a contract consists of one or more contract clauses 604, and each contract clause 604 can be in one of the following formats: (1) event, condition, action (ECA); (2) event, condition, action, metadata; (3) action only; or (4) action and metadata. Compared to traditional QoS, contract 700 operates at a much lower-level-per packet, and instructs in high-level abstract commands.

In some aspects, each contract clause includes an action, and may optionally include a combination of an event, condition (together shown as an event, condition, action (ECA) 606), and metadata 602. Similar to contract 700, the event, condition, action, and metadata of the contract may also be a fixed length or a variable length. In one embodiment, an atomic contract ECA exists in which the event and condition are empty. In other embodiments, a contract can omit the event, condition, and/or metadata fields. Contract clause 604 describes how the nodes in the network architecture 100 treat the packet as it traverses the network based on the event and condition, which may be predefined. Given a predefined event and condition has occurred, various actions are processed by the nodes in the network architecture 100 (e.g., using the node's PMM to perform disclosed functionalities).

For example, to support ultra-reliable low-latency communication (uRLLC) in 5G, two contracts C1 and C2 may be used, where the C1 contract clause indicates a bounded latency action and the C2 contract clause has a NoPktloss action (i.e., the conditions of latency is bounded to low latency, and reliability is achieved through no packets being lost, are both to be met). Actions 800 are described with reference to FIG. 8.

The optional metadata contains data about the packet, e.g. accounting information, customized statistics about the flow on intermediate hops, contextual information about the user and application, etc. The in-network node intelligence is naturally embedded and supported by the New IP framework. FIG. 8 illustrates an example of action 800 that may be specified in a contract clause. An action set 800 includes one or more actions defined in the contract specification field 401c that are known and processed by all New IP nodes (e.g., nodes capable of processing new IP data packets). For example, APP 126 can insert operator-defined and/or application-defined actions. Such actions may be generally categorized into operations, monitoring, telemetry, or signaling.

In some aspects, new contracts as defined in the specification may be implemented across different hardware platforms using different methods or algorithms. However, the result of implementation leads to packet delivery guarantees between the sender and the receiver. Several actions are described below (some of which are shown in action 800 in FIG. 8):
(a) Action BoundedLatency(t) (also referred to as “InTimeGuarantee”) instructs the router to deliver a packet at any time before time t (within a pre-configured unit of time). It may use corresponding metadata to describe an end-to-end network latency or available latency since transmission starts from the sender. In some aspects, an algorithm referred to as latency-based forwarding (LBF) implements this action. Instead of a class of services, contract clauses embed exact parameters and objectives in the packet.
(b) Action OnTimeDevliery(t,t′) with metadata t and t′as a total end-to-end time and elapsed time respectively delivers packet at a specific time to accommodate very low values of time-jitter.
(c) Action Coordinate enables multi-user applications to adjust packet delivery timings in the network. The action may need to identify co-flows, which can be done from the address casting part of the Shipping Spec along with timing dependency parameters as specified in the metadata.
(d) Action NoPacketLoss instructs networks to use every means available to deliver the packet.
(e) Action PreferredPath may instruct the nodes to use a set of node addresses or other forms of path identifiers embedded in the packet to provide guarantees that the packet is transmitted along that set of node addresses or identified paths.
(f) Action PktTrace tracks the packet flow behavior across the network and may be used to understand the end-to-end service assurance and performance degradations in particular. For example, to understand hop-by-hop latency, PktTrace action may capture a path in the network along with the time spent in each node. An end user initiates a contract with a PktTrace action and event indicating “measure time.” Each node in the end-to-end path then inserts its identification and time spent in the metadata of the packet. Similarly, if the PktTrace action is used without any event, then metadata inserted by the node is an identifier. In this way, the service knows the path taken by the packet.
(g) Action PktMonitorhelps gain visibility into the current state of the system. This action captures events in a network relating to queue thresholds, packet drops, etc. Such actions identify situations such as congestion before they occur by monitoring the thresholds. For example, to identify real-time congestion, if a queue at a node is built up to 70%, then this action sets the corresponding metric value in the metadata of the packet, so the information can be retrieved later.
(h) Action ReportInsuringParty is an operator-driven action to be executed when a service objective violation occurs; the node in error is then required to report such violations to the insuring party. Operators can use this functionality for the assessment of damages due to service level objectives violations, which may help build trust between different network systems.

Events are local occurrences or a state of a network node that can impact the behavior of a packet or flow in transit. Events such as queue levels, path changes, drops, etc. determine congestion or fault, while other events may be operands, such as a packet count, next hop, etc. that meet a specific value.

Conditions are arithmetic or logical operators to perform conditional checks. For example, a condition may be set as less than or equal (LE) and greater than or equal (GE). These conditions may be used to check against thresholds, data rates, or any other measure. Several other logical operators, such as OR, XOR, and AND may also be used to derive the results from events and actions. For example, an action may be executed when a queue level (event) is greater than or equal to (condition) a specified threshold.

### Load Saturation Aware Routing

Equal-cost multipath (ECMP) is a network routing strategy that allows for the traffic of the same session (or flow) to be transmitted across multiple best paths of equal cost/routing priority. ECMP was originally designed for load balancing and to fully utilize unused bandwidth on links towards the same destination node. Multi-path routing can be used in conjunction with most routing protocols because it is a per-hop local decision made independently at each router. In aspects when ECMP is used, a single routing metric can be applied to calculate and build the routes with the same cost. An ECMP set could be with a routing table containing multiple next-hop addresses for the same destination with equal cost. Routes of equal cost have the same preference and metric value, which can be referred to as a primary metric. In some aspects, the equal cost next hop towards the destination can be rotated and one of the next-hop addresses in the ECMP set can be installed in the forwarding table based on hashing algorithms.

Instead of using load-balancing as the primary target, the disclosed techniques can be based on leveraging multiple routing paths with the same cost (based on one routing metric) to reduce the energy consumption of the routers. The disclosed techniques can use a secondary metric referred to as a load saturation ratio (LSR), which is a ratio of the traffic load to the maximum peak load that could be supported by a router before congestion happens. As used herein, the term “load” indicates a change in an amount of data over a period of time (e.g., the amount of data transmitted or received by a router over a pre-configured period). Alternatively, the LSR can be a primary metric, an only metric, or used in another way. Further, other metrics similar to the LSR, also measuring the load can be used, such as a difference between the traffic load and the maximum peak load. Each router's interface can be associated with an LSR value. In some aspects, a node (which can include multiple interfaces) can be associated with a single LSR. For example, the LSR for the node can be an average of the LSRs associated with the node's interfaces.

As used herein, the term “saturation metric” includes information indicative of saturation associated with an interface of a router or saturation associated with the entire router. In some aspects, a saturation metric for an individual interface can include the LSR of the interface, an indicator the LSR is below a first threshold (e.g., a threshold that triggers the router to notify other routers in the AS that this interface's LSR is below the first threshold), or an indicator the LSR is below a second threshold (e.g., a threshold which triggers the router to request the interface be turned off). In some aspects, a saturation metric for a router can include the LSR of the router (e.g., an average of the LSRs associated with the router interfaces), an indicator that the LSR of the router is below a first threshold (e.g., a threshold which triggers the router to notify other routers in the AS that the LSRs of all router interfaces are below the first threshold), or an indicator the LSR is below a second threshold (e.g., a threshold which triggers the router to request the router be turned off).

In some embodiments, the LSR can be propagated in the network architecture using the following techniques:
(a) Periodic propagation which can be performed in the same (or similar) way to Link State Advertisements (LSAs) used in the Open Shortest Path First (OSPF) protocol-based devices. In some aspects, the LS type can be set to the value 0×2001 for router-LSA in this scenario. The propagation scope of router-LSAs can be limited in the area. Each router-LSA contains an integral number of interface descriptions. Each interface description is 16 bytes long and consists of five fields: (interface) Type, Metric, Interface ID, Neighbor Interface ID, and Neighbor Router ID. In some aspects, the Metric field can be used to store the LSR value for the corresponding Interface ID, Neighbor Interface ID, and Neighbor Router ID combination. The router-LSAs originated from a router and have a collection of link descriptions that include the LSR values for all the router's interfaces attached to the area.
(b) On-path propagation by recording the LSR information in the packet header (e.g., using the New IP metadata field in the New IP packet header) when a packet is forwarded by routers. As explained in connection with FIGS. 4-9, New IP defines a new network datagram format (e.g., as shown in FIG. 4). It is an extension, optimization, and evolution of IP with new functions (capabilities, features), and is being designed to be inter-operable with IPv4/v6 and many others. Each New IP contract could optionally include the metadata associated with the parties involved in the contract. In some aspects, the New IP metadata would attach the router's LSR values for all its interfaces when the New IP packet is forwarded by the router. As a result, a router on a communication path to a destination node can extract the LSR information of the router(s) between itself and the source node of the packet.

In some aspects, the most up-to-date LSR value is overwritten by the latest value from either of the above techniques. Each router computes and maintains the largest-average-LSR-path tree for each route using a method based on, e.g., Dijkstra's algorithm. The average LSR value of the path can be re-calculated whenever the most recent LSR value of any router on the path is received by the router. For a router that finds there are multiple paths for a destination and supports ECMP based on the primary metric, such a router can decide to forward the flow to the path with the highest average LSR. More generally, the router can store information about the saturation at multiple nodes in its area, and forward the flow to a path with a higher saturation (measured by average LSR or another metric/indicator such as the “drowsy” indicator further described below). Under the above forwarding strategy, some routers may have little traffic (or some interfaces of a router may have little traffic). A router might request to be turned off (e.g., by a management node) when it is in an idle state or with a small traffic load. In some aspects, a router can turn off one or more of its interfaces when there is no traffic or very little traffic through such interfaces.

FIG. 10 is an example network architecture topology 1000, according to some example embodiments. Referring to FIG. 10, the network architecture topology 1000 includes nodes 1002, 1004, 1006, 1008, 1010, and 1012 coupled in the illustrated configuration. Nodes 1002-1012 (which can be routers or other computing devices) can also be referred to as nodes 1, 2, 3, 4, 5, 6 (or routers 1, 2, 3, 4, 5, and 6) respectively.

In some aspects, before an interface of a router is going to be turned off, the router can send an LSA regarding the primary metric value of the interface, which is set to infinity. Similarly, when a router is going to be put in sleep mode (also referred to as sleeping mode or sleeping status), the router sends the last LSA regarding the primary metric values of all interfaces, which are set to infinity, indicating that the router is no longer reachable or connected to the network. In some aspects, the router that is going to be placed in sleeping mode can broadcast a notification that the router is in a drowsy state. The drowsy state can be associated with the router being turned off within a preconfigured interval after the notification message is broadcast.

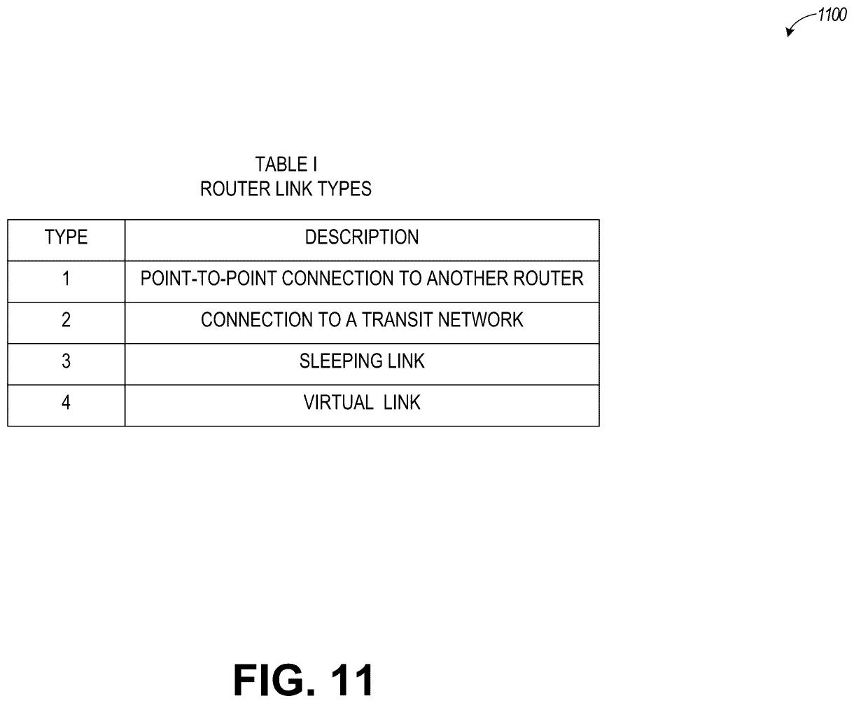

However, the above configuration (e.g., unavailability is temporary due to its sleep mode) can be distinguished as different from the configuration when the router is malfunctioning or being completely removed from the network. In some aspects, the disclosed techniques can be configured with a new router link type (e.g., sleeping link) to the current definition in the OSPF specification (e.g., as listed in Table I of FIG. 11)

FIG. 11 is diagram 1100 of a table with example router link types, according to some example embodiments. Referring to FIG. 11, in Table I, the Type 3 router link type is changed from “Reserved” to “Sleeping Link”. In this regard, after a certain processing time, the routing algorithm would converge such that the associated routing path through the sleeping interface or router will become invalid.

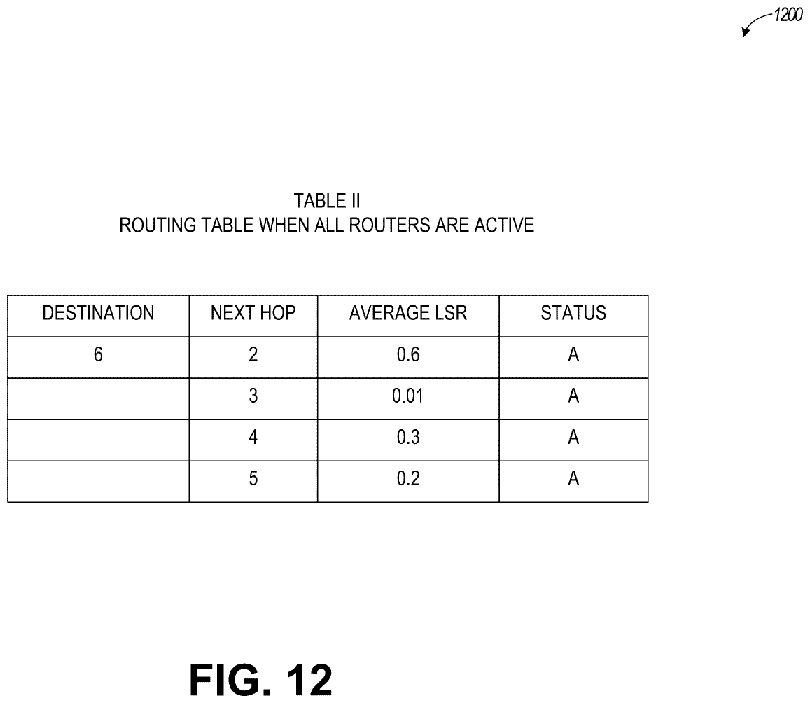

In reference to the network topology of FIG. 10, the routing table that considers both the primary metric (e.g., the number of hops) and the secondary metric (e.g., the LSR as discussed herein) can be configured as illustrated in Table II of FIG. 12.

FIG. 12 is a diagram of a routing table 1200 when all routers of the network architecture topology of FIG. 10 are active, according to some example embodiments.

For a single destination, there could be multiple next-hop nodes indicating the multiple routing paths toward the destination. Some of the multiple routing paths might share the same next hop. The average LSR field shows the average LSR value of all routers on a path toward the destination. The status field shows whether all the routers on a particular path are active or not. If all the routers are active, then an “A” status would reflect such a configuration. Other routers may not take the same actions under such a scenario compared to a long-term router failure or removal scenario. In other words, the turned-off interface or sleeping router could be turned on and waken again if the other routers are saturated (e.g., above a threshold level), indicating congestion will occur. In some embodiments associated with ECMP implementation, the routers do not remove the invalid routing option but label it as sleeping (S).

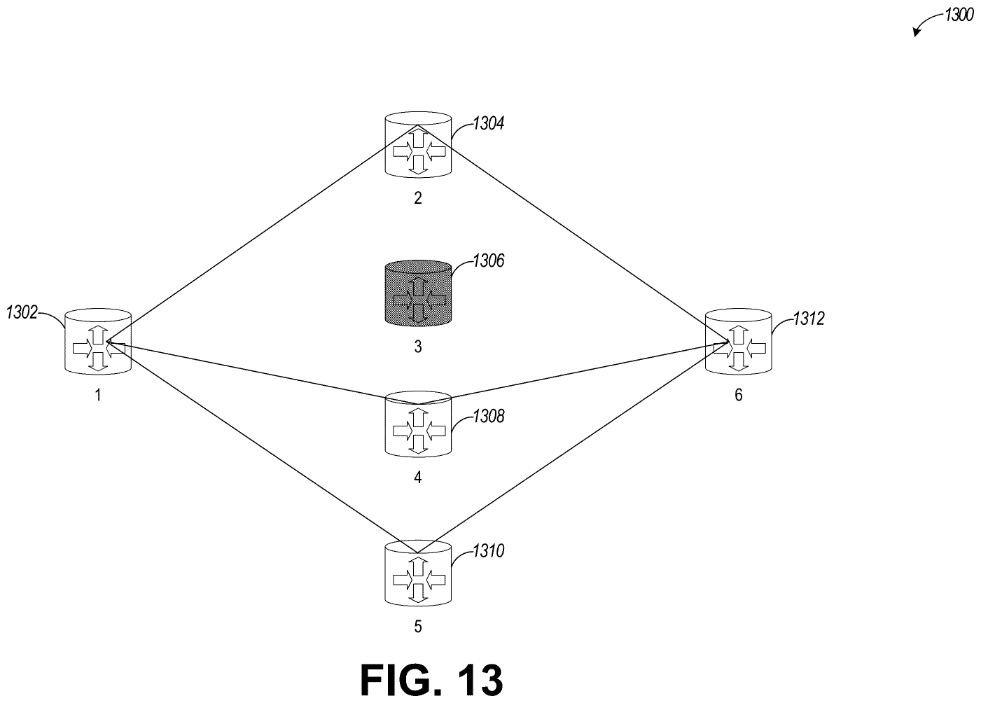

FIG. 13 is an example network architecture topology 1300 with one router configured in a sleeping mode, according to some example embodiments. Referring to FIG. 13, the network architecture topology 1300 includes nodes 1302, 1304, 1306, 1308, 1310, and 1312 coupled in the illustrated configuration, with node 1306 being in sleeping mode. Nodes 1302-1312 (which can be routers or other computing devices) can also be referred to as nodes 1, 2, 3, 4, 5, 6 (or routers 1, 2, 3, 4, 5, and 6) respectively.

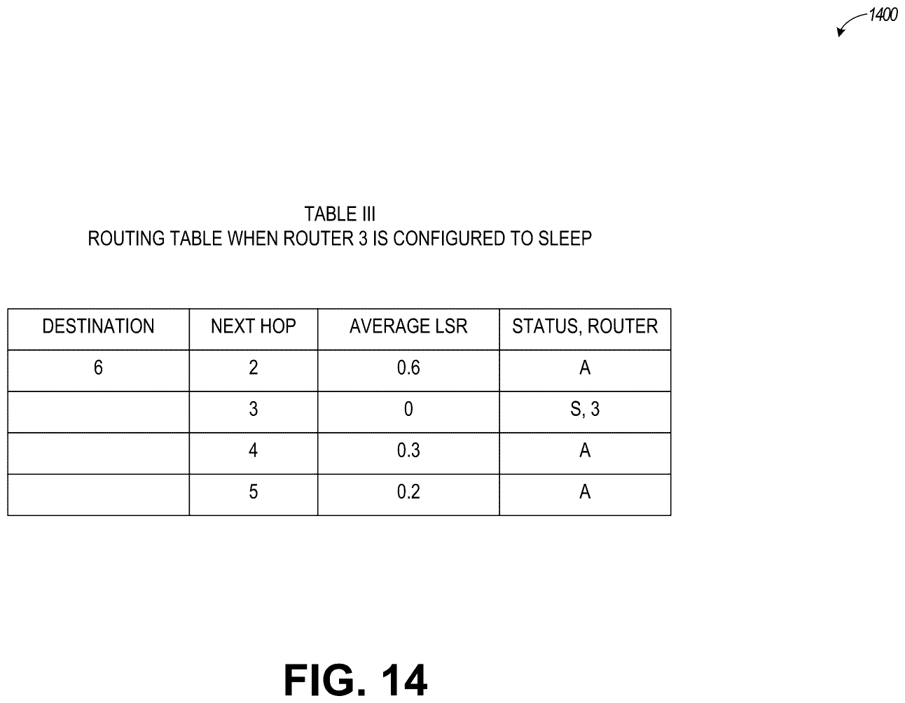

In some aspects, the sleeping status (S) indication would imply that the turned-off router is being put in sleeping mode and can be woken up if its traffic load is saturated and starts to congest. If any of the routers on the path is placed in sleeping mode or is turned on temporarily (e.g., router 3 is configured in sleeping mode as illustrated in FIG. 13), then the status of the corresponding path indicated by the next hop is set to “S” and any sleeping router(s) on the path would be recorded next to the “S” status (e.g., as illustrated in Table III of FIG. 14).

FIG. 14 is a diagram of a routing table 1400 associated with the network architecture topology of FIG. 13 when one router is in a sleeping mode, according to some example embodiments.

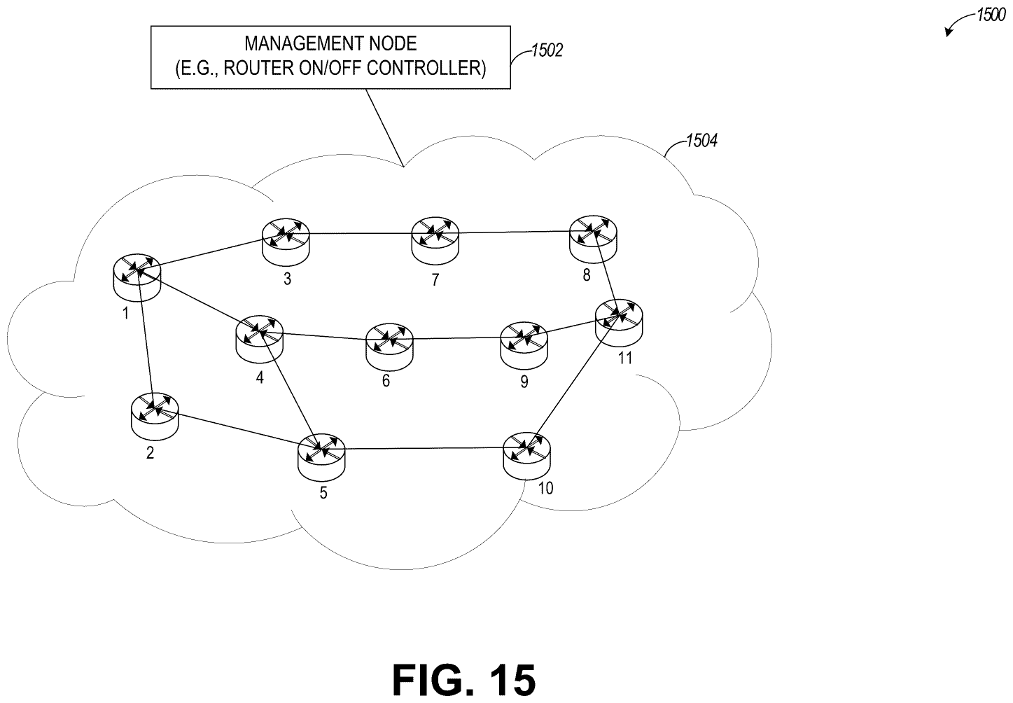

FIG. 15 is an example network architecture topology 1500 with a management node, according to some example embodiments. Referring to FIG. 15, the network architecture topology 1500 includes a management node 1502 (e.g., an orchestrator node or a router on/off controller) and an autonomous system (AS) 1504. The AS 1504 includes nodes 1-11, which can be similar to other nodes discussed herein (e.g., in connection with FIGS. 1-14). An example of a router on/off procedure to save energy consumption in a network architecture is discussed herein below.

For an example communication flow sourced from router 1 to router 11, router 1 can be configured to support ECMP so that the following four equal cost paths towards router 11 based on the primary routing metric (e.g, number of hops) exist:
(a) Path 1: Router 1→Router 3→Router 7→Router 8→Router 11;
(b) Path 2: Router 1→Router 4→Router 6→Router 9→Router 11;
(c) Path 3: Router 1→Router 4→Router 5→Router 10→Router 11; and
(d) Path 4: Router 1→Router 2→Router 5→Router 10→Router 11.

In some aspects, router 1 maintains a routing table which can be the same as Table II. For the destination node (e.g., router 11), there are three next-hop nodes: 3, 4, and 2. In the meantime, router 1 also maintains the most recent average LSR value of the four paths (path 2 and path 3 share the same next hop node 4). It can be assumed that based on the average LSR value, router 1 forwards the traffic to router 4, i.e., path 2 or path 3 has the highest LSR value and is selected for communication. In some aspects, if the LSR value of a path is high (e.g., above a pre-configured threshold), it indicates the routers on the path are likely to be overloaded, then the traffic can be directed to other paths associated with the next lower LSR value.

Router 4 also supports ECMP and there are two equal-cost paths toward router 11. Based on the average LSR value, router 4 forwards the traffic to router 6, i.e., path 2 has the highest LSR value and is selected.

Path 2 can be configured as Router 4→Router 6→Router 9→Router 11. Path 3 can be configured as Router 4→Router 5→Router 10→Router 11. The traffic load on those routers of the path (i.e., router 4, router 6, router 9) is more likely to be gradually saturated, while other routers can have very low traffic load even at their idle status. When a router (e.g., router 7) detects that it has been idle for a pre-defined length of time, it can send a request to management node 1502 to be turned off. For example, in router 1, regarding destination router 11, there would be three active routing paths remaining. The path with router 3 as the next hop node will be under the status of “S”, and the sleeping router on this path is router 7, which is recorded next to the “S” status in the routing table.

Before router 7 is turned off, the last LSA is sent from router 7 to indicate that the primary metric value of all interfaces of router 7 is infinity. The routing table of all other routers in the AS 1504 would be updated and converged to reflect the status of the router is turned off.

After router 7 is turned off, the traffic would be offloaded by other paths. If some router on those other paths becomes overloaded (e.g., router 6) and the LSR is above the threshold, and router 6 also detects that traffic destinations are those affected destinations due to router 7 being turned off, then router 6 can request the management node 1502 to turn on router 7.

### Improving the Likelihood of Putting a Router in a Sleeping Mode

The disclosed techniques described above can be used to put a router's interface or even an entire router into a sleeping state in the non-sophisticated network topology configurations. However, the topology in an AS can be more complicated, and the network traffic can be configured from multiple directions. In some embodiments, for an interface of a router to be placed into a sleeping state, it requires that all the traffic in the network would not use this interface. In some embodiments, for a router to be able to go to sleep, it can require that all the traffic in the network would not use any interface of the router. To increase the likelihood for an interface or the entire router's interfaces to have little or even no traffic, the disclosed techniques further include the mechanisms described below in the Interface Scenario and the Entire Router Scenario.
(a) Interface Scenario. In some embodiments, the following two thresholds can be configured for a router's interface:
(a.1) triggerTi: This parameter can be defined as the threshold that triggers the router to notify other routers in the AS that this interface's LSR is below a certain threshold. When other routers receive such notification, they will try to avoid using the routing path that includes the link associated with the interface.
(a.2) sleepTi: This parameter can be defined as the threshold that triggers the router to request the controller to turn the interface off if the LSR of the interface is below that threshold.

When a router (e.g., router 7 in FIG. 15) detects that one of its interface's LSR is below triggerTi, it will send a notification in the control plane, where the notification includes information identifying the link associated with the interface (e.g., router 7→router 8 in FIG. 15). Alternatively, the router could send a New IP message in the data plane, which includes the same information in the metadata field.

In some aspects, the notification message can be used to describe the subsequent procedures. In some aspects, the notification message can be broadcast in the AS. After a router receives the notification message, for any (Destination, Next Hop) combination (corresponding to a routing path towards the destination) that involves the link, the status of the (Destination, Next Hop) combination is changed to “D (drowsy)”, which means that one of the links on the routing path is likely to change into sleeping status soon. In this regard, forwarding the traffic on the path can be avoided if there is an alternative one.
(b) Entire Router Scenario. For a router to be able to switch to sleep mode, the traffic going through all its interface needs to be minimal. If a router's interfaces are in sleep status, then the entire router could be requested to be turned off. The following two thresholds can be defined (similar to the interface scenario):
(b.1) triggerTR. This parameter can be defined as the threshold that triggers the router to notify other routers in the AS that its entire LSR of all interfaces is below a certain threshold. When other routers receive such notification, they can try to avoid using the routing path that includes the router as the intermediate node.
(b.2) sleepTR. This parameter can be defined as the threshold that triggers the router to request the controller to turn itself off if the entire LSR of all interfaces is below that threshold.

In some aspects, when a router (e.g., router 7 in FIG. 15) detects that all of its interfaces are in sleep mode, then it can request the controller to turn itself off completely.

In some aspects, if a router (e.g., router 7 in FIG. 15) detects that the overall LSR of all its interfaces is below triggerTR, then it can send a notification in the control plane, which includes the information of being in a “drowsy” state. The notification message can be broadcast in the AS. After a router receives the notification message, for any (Destination, Next Hop) combination (corresponding to a routing path towards the destination) that has the advertised router as one of the intermediate nodes, the status of the (Destination, Next Hop) combination is changed to “D (drowsy)”, which means that one of the intermediate nodes on the routing path is likely to be switched off completely. In this case, forwarding the traffic toward the next hop node can be avoided if there is an alternative one.

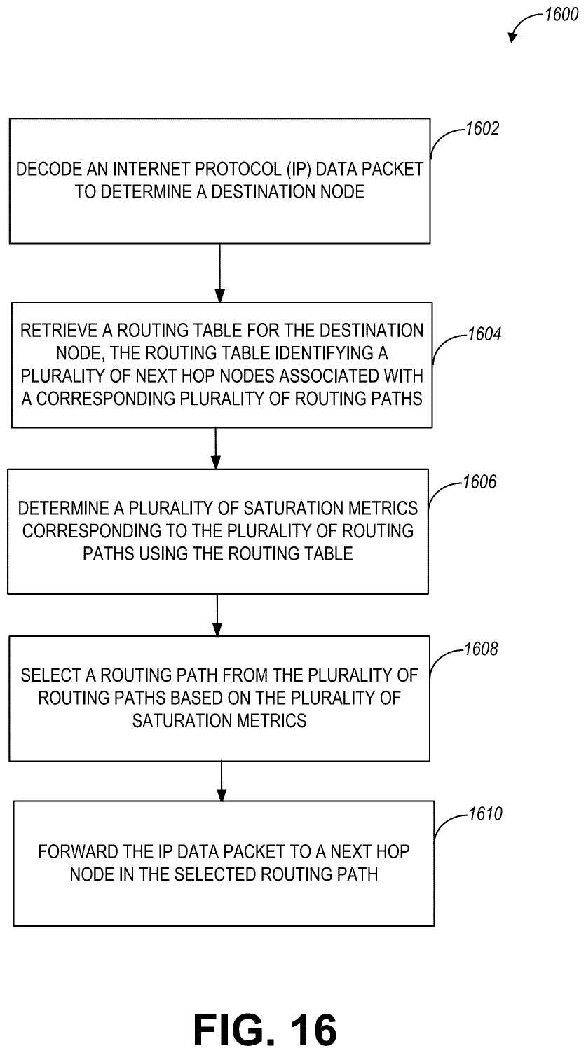

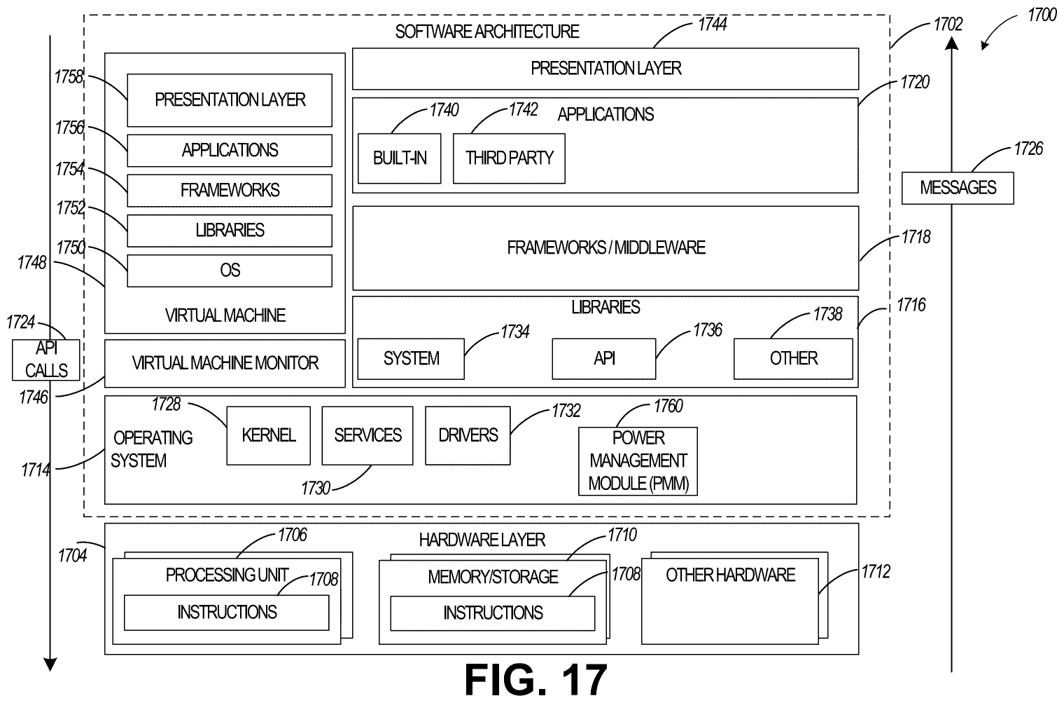

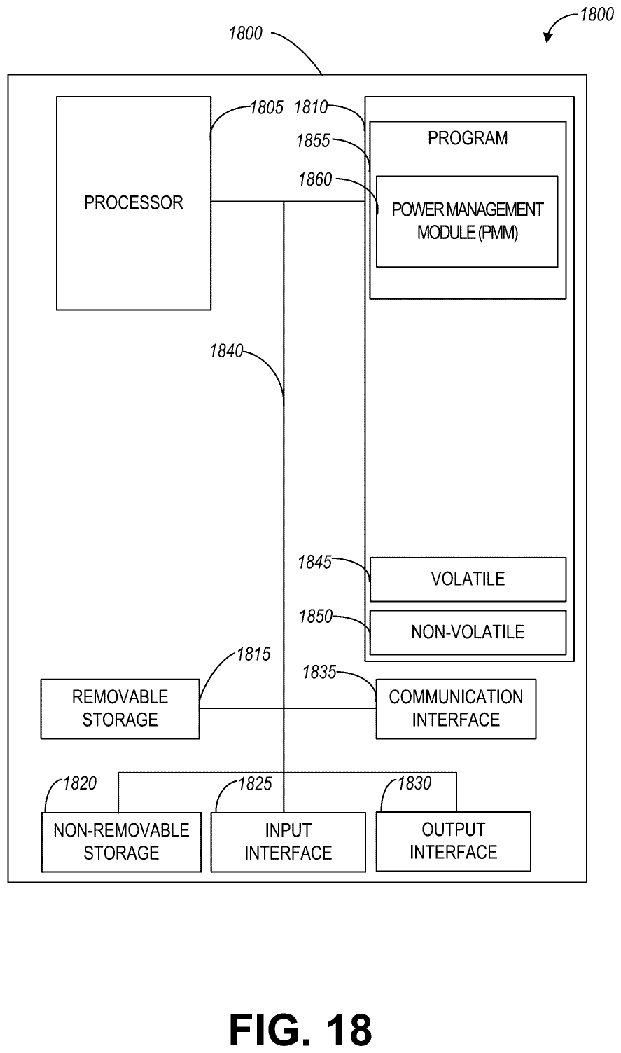

FIG. 16 is a flowchart of method 1600 suitable for data packet communication and processing, according to some example embodiments. Method 1600 includes operations 1602, 1604, 1606, 1608, and 1610. By way of example and not limitation, method 1600 is described as being performed by the PMM 136 (also referenced as the PMM 1760 of FIG. 17 or PMM 1860 of FIG. 18).

At operation 1602, an Internet protocol (IP) data packet is decoded to determine a destination node. For example, data packet 134 is received and decoded by node 104 to determine a destination node (e.g., destination node 104 is determined based on the header information).

At operation 1604, a routing table (e.g., routing table 1400) is retrieved for the destination node. The routing table identifies a plurality of next-hop nodes associated with a corresponding plurality of routing paths to the destination node.

At operation 1606, a plurality of saturation metrics (e.g., LSR values) corresponding to the plurality of routing paths are determined using the routing table. Each of the plurality of saturation metrics is indicative of data traffic saturation along a corresponding one of the plurality of routing paths.

At operation 1608, a routing path is selected from the plurality of routing paths based on the plurality of saturation metrics. For example, the next hop node from the routing path associated with the highest LSR can be selected.

At operation 1610, the IP data packet is forwarded to the next hop node in the selected routing path.

In some aspects, the selecting of the routing path further includes selecting the highest saturation metric from the plurality of saturation metrics, where the highest saturation metric corresponds to the routing path. In some embodiments, the PMM detects the highest saturation metric is higher than a threshold saturation metric. In some aspects, a second routing path is selected from the plurality of routing paths. The second routing path has a second highest saturation metric from the plurality of saturation metrics. Routing the IP data packet is switched from the selected routing path to the second routing path.

In some embodiments, the plurality of saturation metrics is a plurality of average load saturation ratios (LSRs) corresponding to the plurality of routing paths. In some aspects, an average LSR of the plurality of average LSRs corresponds to the selected routing path based on at least one ratio of data traffic load to a maximum peak load supported by a node in the selected routing path before data traffic congestion occurs at the node.

In some aspects, the routing table can be parsed to further determine an average saturation metric and communication status for at least a first set of nodes forming the selected routing path and a second set of nodes forming a second routing path of the plurality of routing paths. In some aspects, the PMM detects the network congestion for the selected routing path is above a threshold congestion level. The communication status in the routing table for a node of the second set of nodes is detected to indicate the node is turned off.

In some aspects, a configuration message is encoded for transmission to a management node of the communication network based on detecting the network congestion and the communication status. The configuration message requests the management node to turn on the node of the second set of nodes.

In some aspects, the PMM detects available communication interfaces of the source node that have been idle for a threshold duration and encodes a configuration message for transmission to a management node of the communication network. The configuration message requests the management node to turn off the source node.

In some aspects, the PMM encodes, before the management node turns off the source node, a notification message for a broadcast within the communication network. The notification message includes at least a first field indicating the average saturation metric for each of the available communication interfaces, and at least a second field indicating a sleeping status of the source node.

In some aspects, the notification message is a link state advertisement (LSA) message, the at least a first field comprises a metric field, and the at least a second field comprises a type field. In some aspects, the at least a first field is a metadata field of the notification message.

In some aspects, the communication status of the source node listed in the routing table is updated to indicate the sleeping status.

In some aspects, the PMM detects a communication interface of a plurality of available communication interfaces of the source node that have been idle for a threshold duration. The PMM encodes a configuration message for transmission to a management node of the communication network. The configuration message requests the management node to turn off the communication interface.

In some aspects, the PMM encodes, before the management node turns off the communication interface, a notification message for a broadcast within the communication network. The notification message includes at least a first field indicating the average saturation metric for the communication interface, and at least a second field indicating a sleeping status of the communication interface.

In some aspects, the communication status of the source node listed in the routing table is updated to indicate the sleeping status.

In some embodiments, the routing table is parsed to determine an average saturation metric and communication status for a plurality of nodes forming the plurality of routing paths.

In some embodiments, a notification message broadcast by at least one node of the plurality of nodes is decoded. The at least one node is associated with a second routing path of the plurality of routing paths. The notification message indicates the average saturation metric for a communication interface of the at least one node is below a threshold saturation metric.

In some aspects, the second routing path is excluded from the plurality of routing paths during the selecting of the routing path, based on the notification message.

FIG. 17 is a block diagram illustrating a representative software architecture 1700, which may be used in conjunction with various device hardware described herein, according to some example embodiments. FIG. 17 is merely a non-limiting example of software architecture 1702 and it will be appreciated that many other architectures may be implemented to facilitate the functionality described herein. The software architecture 1702 may be executed on hardware such as computing device 1800 of FIG. 18 that includes, among other things, processor 1805, memory 1810, storage 1815 and 1820, and I/O components (or interfaces) 1825 and 1830. A representative hardware layer 1704 is illustrated and can represent, for example, the computing device 1800 of FIG. 18. The representative hardware layer 1704 comprises one or more processing units 1706 having associated executable instructions 1708. Executable instructions 1708 represent the executable instructions of the software architecture 1702, including the implementation of the methods, modules, and so forth of FIGS. 1-16. Hardware layer 1704 also includes memory and/or storage modules 1710, which also have executable instructions 1708. Hardware layer 1704 may also comprise other hardware 1712, which represents any other hardware of the hardware layer 1704, such as the other hardware illustrated as part of computing device 1800.

In the example architecture of FIG. 17, the software architecture 1702 may be conceptualized as a stack of layers where each layer provides particular functionality. For example, the software architecture 1702 may include layers such as an operating system 1714, libraries 1716, frameworks/middleware 1718, applications 1720, and presentation layer 1744. Operationally, the applications 1720 and/or other components within the layers may invoke application programming interface (API) calls 1724 through the software stack and receive a response, returned values, and so forth illustrated as messages 1726 in response to the API calls 1724. The layers illustrated in FIG. 17 are representative in nature and not all software architectures 1702 have all layers. For example, some mobile or special purpose operating systems may not provide frameworks/middleware 1718, while others may provide such a layer. Other software architectures may include additional or different layers.

The operating system 1714 may manage hardware resources and provide common services. The operating system 1714 may include, for example, a kernel 1728, services 1730, drivers 1732, and a PMM 1760. The kernel 1728 may act as an abstraction layer between the hardware and the other software layers. For example, kernel 1728 may be responsible for memory management, processor management (e.g., scheduling), component management, networking, security settings, and so on. Services 1730 may provide other common services for the other software layers. The Driver 1732 may be responsible for controlling or interfacing with the underlying hardware. For instance, the drivers 1732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

In some aspects, the PMM 1760 can be the same as (and perform the same functionalities as) the PMM 136 discussed in connection with FIG. 1-FIG. 16.

The libraries 1716 may provide a common infrastructure that may be utilized by the applications 1720 and/or other components and/or layers. The libraries 1716 typically provide functionality that allows other software modules to perform tasks more easily than to interface directly with the underlying operating system 1714 functionality (e.g., kernel 1728, services 1730, drivers 1732, and/or PMM 1760). The libraries 1716 may include system libraries 1734 (e.g., C standard library) that may provide functions such as memory allocation functions, string manipulation functions, mathematic functions, and the like. In addition, the libraries 1716 may include API libraries 1736 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1716 may also include a wide variety of other libraries 1738 to provide many other APIs to the applications 1720 and other software components/modules.

The frameworks/middleware 1718 (also sometimes referred to as middleware) may provide a higher-level common infrastructure that may be utilized by the applications 1720 and/or other software components/modules. For example, the frameworks/middleware 1718 may provide various graphical user interface (GUI) functions, high-level resource management, high-level location services, and so forth. The frameworks/middleware 1718 may provide a broad spectrum of other APIs that may be utilized by the applications 1720 and/or other software components/modules, some of which may be specific to a particular operating system 1714 or platform.

The applications 1720 include built-in applications 1740 and/or third-party applications 1742. Examples of representative built-in applications 1740 may include but are not limited to, a contacts application, a browser application, a book reader application, a location application, a media application, a messaging application, and/or a game application. Third-party applications 1742 may include any of the built-in applications 1740 as well as a broad assortment of other applications. In a specific example, the third-party application 1742 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1742 may invoke the API calls 1724 provided by the mobile operating system such as operating system 1714 to facilitate the functionality described herein.

The applications 1720 may utilize built-in operating system functions (e.g., kernel 1728, services 1730, drivers 1732, and/or PMM 1760), libraries (e.g., system libraries 1734, API libraries 1736, and other libraries 1738), and frameworks/middleware 1718 to create user interfaces to interact with users of the system. Alternatively, or additionally, in some systems, interactions with a user may occur through a presentation layer, such as presentation layer 1744. In these systems, the application/module “logic” can be separated from the aspects of the application/module that interact with a user.

Some software architectures utilize virtual machines. In the example of FIG. 17, this is illustrated by virtual machine 1748. A virtual machine creates a software environment where applications/modules can execute as if they were executing on a hardware machine (such as the computing device 1800 of FIG. 18, for example). A virtual machine 1748 is hosted by a host operating system (operating system 1714 in FIG. 17) and typically, although not always, has a virtual machine monitor 1746, which manages the operation of the virtual machine 1748 as well as the interface with the host operating system (i.e., operating system 1714). A software architecture 1702 executes within the virtual machine 1748 such as an operating system 1750, libraries 1752, frameworks/middleware 1754, applications 1756, and/or presentation layer 1758. These layers of software architecture executing within the virtual machine 1748 can be the same as the corresponding layers previously described or may be different.

FIG. 18 is a block diagram illustrating circuitry for a device that implements algorithms and performs methods, according to some example embodiments. All components need not be used in various embodiments. For example, clients, servers, and cloud-based network devices may each use a different set of components, or in the case of servers, larger storage devices.

One example computing device in the form of a computer 1800 (also referred to as computing device 1800, computer system 1800, or computer 1800) may include a processor 1805, memory 1810, removable storage 1815, non-removable storage 1820, input interface 1825, output interface 1830, and communication interface 1835, all connected by a bus 1840. Although the example computing device is illustrated and described as the computer 1800, the computing device may be in different forms in different embodiments.

Memory 1810 may include volatile memory 1845 and non-volatile memory 1850 and may store a program 1855. The computer 1800 may include—or have access to a computing environment that includes—a variety of computer-readable media, such as the volatile memory 1845, the non-volatile memory 1850, the removable storage 1815, and the non-removable storage 1820. Computer storage includes random-access memory (RAM), read-only memory (ROM), erasable programmable read-only memory (EPROM) and electrically erasable programmable read-only memory (EEPROM), flash memory or other memory technologies, compact disk read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer-readable instructions stored on a computer-readable medium (e.g., the program 1855 stored in the memory 1810) are executable by the processor 1805 of the computer 1800. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed on and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example. As used herein, the terms “computer-readable medium” and “machine-readable medium” are interchangeable.

The program 1855 may utilize modules discussed herein, such as a PMM 1860 which can be the same as (and perform the same functionalities as) the PMM 136 discussed in connection with FIG. 1-FIG. 17.

Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In some aspects, the disclosed functionalities can be performed by one or more separate (or dedicated) modules included in the PMM 1860 and integrated as a single module, performing the corresponding functions of the integrated module.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above concerning any one or all of the steps of the disclosure can be installed in and sold with one or more computing devices consistent with the disclosure. Alternatively, the software can be obtained and loaded into one or more computing devices, including obtaining software through a physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components outlined in the description or illustrated in the drawings. The embodiments herein are capable of other embodiments and capable of being practiced or carried out in various ways. Also, it will be understood that the phraseology and terminology used herein are for descriptive purposes and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative and are employed to aid illustration but are not limiting.

The components of the illustrative devices, systems, and methods employed in accordance with the illustrated embodiments can be implemented, at least in part, in digital electronic circuitry, analog electronic circuitry, or computer hardware, firmware, software, or combinations of them. These components can be implemented, for example, as a computer program product such as a computer program, program code, or computer instructions tangibly embodied in an information carrier, or a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or another unit suitable for use in a computing environment. A computer program can be deployed to be executed on one computer or multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code, or instructions to perform functions (e.g., by operating on input data and/or generating an output). Method steps can also be performed, and the apparatus for performing the methods can be implemented as, special-purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, an FPGA, or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory, or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated into special-purpose logic circuitry.

Those with skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” (or “computer-readable medium”) means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium (or a combination of multiple media) that is capable of storing instructions for execution by one or more processors 1805, such that the instructions, when executed by one or more processors 1805, cause the one or more processors 1805 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the scope disclosed herein.

Although the present disclosure has been described concerning specific features and embodiments thereof, it is evident that various modifications and combinations can be made thereto without departing from the scope of the disclosure. For example, other components may be added to, or removed from, the described systems. The specification and drawings are, accordingly, to be regarded simply as an illustration of the disclosure as defined by the appended claims, and are contemplated to cover any modifications, variations, combinations, or equivalents that fall within the scope of the present disclosure. Other aspects may be within the scope of the following claims.

What is claimed is:

1. A computer-implemented method for routing data traffic in a communication network, comprising:
decoding, by a source node in the communication network, an Internet protocol (IP) data packet to determine a destination node;
retrieving, by the source node, a routing table for the destination node, the routing table identifying a plurality of next hop nodes associated with a corresponding plurality of routing paths to the destination node;
determining, by the source node, a plurality of saturation metrics corresponding to the plurality of routing paths using the routing table, each of the plurality of saturation metrics indicative of data traffic saturation along a corresponding one of the plurality of routing paths;
selecting a routing path from the plurality of routing paths based on the plurality of saturation metrics; and
forwarding the IP data packet to a next hop node in the selected routing path.

2. The computer-implemented method of claim 1, wherein the selecting of the routing path further comprises:
selecting a highest saturation metric from the plurality of saturation metrics, the highest saturation metric corresponding to the routing path; and
detecting the highest saturation metric is higher than a threshold saturation metric.

3. The computer-implemented method of claim 2, further comprising:
selecting a second routing path from the plurality of routing paths, the second routing path having a second highest saturation metric from the plurality of saturation metrics; and
switching routing the IP data packet from the selected routing path to the second routing path.

4. The computer-implemented method of claim 1, further comprising:
parsing the routing table to further determine a saturation metric and communication status for at least a first set of nodes forming the selected routing path and a second set of nodes forming a second routing path of the plurality of routing paths;
detecting network congestion for the selected routing path is above a threshold congestion level;
detecting the communication status in the routing table for a node of the second set of nodes indicates the node is turned off; and
encoding a configuration message for transmission to a management node of the communication network based on detecting the network congestion and the communication status, the configuration message requesting the management node to turn on the node of the second set of nodes.

5. The computer-implemented method of claim 4, further comprising:
detecting available communication interfaces of the source node have been idle for a threshold duration; and
encoding a configuration message for transmission to a management node of the communication network, the configuration message requesting the management node to turn off the source node.

6. The computer-implemented method of claim 5, further comprising:
encoding a notification message for a broadcast within the communication network, the notification message including:
at least a first field indicating the saturation metric for each of the available communication interfaces; and
at least a second field indicating a sleeping status of the source node.

7. The computer-implemented method of claim 1, further comprising:
parsing the routing table to determine a saturation metric and communication status for a plurality of nodes forming the plurality of routing paths.

8. The computer-implemented method of claim 7, further comprising:
decoding a notification message broadcast by at least one node of the plurality of nodes, the at least one node associated with a second routing path of the plurality of routing paths, and the notification message indicating the saturation metric for a communication interface of the at least one node is below a threshold saturation metric.

9. The computer-implemented method of claim 8, further comprising:
excluding the second routing path from the plurality of routing paths during the selecting of the routing path, based on the notification message.

10. A source node for routing data traffic in a communication network, the source node comprising:
a non-transitory memory storing instructions; and
at least one processor in communication with the memory, the at least one processor configured, upon execution of the instructions, to perform the following steps:
decoding an Internet protocol (IP) data packet to determine a destination node;
retrieving a routing table for the destination node, the routing table identifying a plurality of next hop nodes associated with a corresponding plurality of routing paths to the destination node;
determining a plurality of saturation metrics corresponding to the plurality of routing paths using the routing table, each of the plurality of saturation metrics indicative of data traffic saturation along a corresponding one of the plurality of routing paths;
selecting a routing path from the plurality of routing paths based on the plurality of saturation metrics; and
forwarding the IP data packet to a next hop node in the selected routing path.

11. The source node of claim 10, wherein the selecting of the routing path further comprises the following steps:
selecting a highest saturation metric from the plurality of saturation metrics, the highest saturation metric corresponding to the routing path; and
detecting the highest saturation metric is higher than a threshold saturation metric.

12. The source node of claim 11, wherein the at least one processor is configured, upon execution of the instructions, to perform the following steps:
selecting a second routing path from the plurality of routing paths, the second routing path having a second highest saturation metric from the plurality of saturation metrics; and
switching routing the IP data packet from the selected routing path to the second routing path.

13. The source node of claim 10, wherein the at least one processor is configured, upon execution of the instructions, to perform the following steps:
parsing the routing table to further determine a saturation metric and communication status for at least a first set of nodes forming the selected routing path and a second set of nodes forming a second routing path of the plurality of routing paths;
detecting network congestion for the selected routing path is above a threshold congestion level;
detecting the communication status in the routing table for a node of the second set of nodes indicates the node is turned off; and
encoding a configuration message for transmission to a management node of the communication network based on detecting the network congestion and the communication status, the configuration message requesting the management node to turn on the node of the second set of nodes.

14. The source node of claim 13, wherein the at least one processor is configured, upon execution of the instructions, to perform the following steps:
detecting available communication interfaces of the source node have been idle for a threshold duration; and
encoding a configuration message for transmission to a management node of the communication network, the configuration message requesting the management node to turn off the source node.

15. The source node of claim 14, wherein the at least one processor is configured, upon execution of the instructions, to perform the following step:
encoding a notification message for a broadcast within the communication network, the notification message including:
at least a first field indicating the saturation metric for each of the available communication interfaces; and
at least a second field indicating a sleeping status of the source node.

16. The source node of claim 10, wherein the at least one processor is configured, upon execution of the instructions, to perform the following step:
parsing the routing table to determine a saturation metric and communication status for a plurality of nodes forming the plurality of routing paths.

17. The source node of claim 16, wherein the at least one processor is configured, upon execution of the instructions, to perform the following step:
decoding a notification message broadcast by at least one node of the plurality of nodes, the at least one node associated with a second routing path of the plurality of routing paths, and the notification message indicating the saturation metric for a communication interface of the at least one node is below a threshold saturation metric.

18. The source node of claim 17, wherein the at least one processor is configured, upon execution of the instructions, to perform the following step:
excluding the second routing path from the plurality of routing paths during the selecting of the routing path, based on the notification message.

19. A non-transitory computer-readable medium storing computer instructions for routing data traffic in a communication network, that configure at least one processor, upon execution of the instructions, to perform the following steps:
decoding an Internet protocol (IP) data packet to determine a destination node;
retrieving a routing table for the destination node, the routing table identifying a plurality of next hop nodes associated with a corresponding plurality of routing paths to the destination node;
determining a plurality of saturation metrics corresponding to the plurality of routing paths using the routing table, each of the plurality of saturation metrics indicative of data traffic saturation along a corresponding one of the plurality of routing paths;
selecting a routing path from the plurality of routing paths based on the plurality of saturation metrics; and
forwarding the IP data packet to a next hop node in the selected routing path.
